(19) United States
(12) Patent Application Publication
(10) Pub. No.: US 2014/0081624 A1
(43) Pub. Date: Mar. 20, 2014

(54) Methods, Systems, and Program Products for Navigating Tagging Contexts

(71) Applicant: DEEP RIVER VENTURES, LLC, Raleigh, NC (US)

(72) Inventor: Robert Paul Morris, Raleigh, NC (US)

(73) Assignee: DEEP RIVER VENTURES, LLC, Raleigh, NC (US)

(21) Appl. No.: 13/622,372

(22) Filed: Sep. 19, 2012

(51) Int. Cl. G06F 17/27

(52) U.S. Cl. 704/9

(57) ABSTRACT

Methods and systems are described for navigating tagging contexts. In an aspect, In a first tagging context, a first tagging is identified of a first resource with a first tag. The first tagging is determined to be in a second tagging context. In the second tagging context and in response to identifying the first tagging, a second tagging that is not in the first tagging context is detected.

### RELATED APPLICATIONS

This application is related to the following commonly owned U.S. patent applications: application Ser. No. 13/622,366 (Docket No DRV0002) filed on 2012/09/19, entitled “Methods, Systems, and Program Products for Tagging a Resource”;

Application Ser. No. 13/622,367 (Docket No DRV0005) filed on 2012/09/19, entitled “Methods, Systems, and Program Products for Distinguishing Tags for a Resource”;

Application Ser. No. 13/622,370 (Docket No DRV0008) filed on 2012/09/19 entitled “Methods, Systems, and Program Products for Automatically Managing Tagging of a Resource”;

Application Ser. No. 13/622,371 (Docket No DRV0009) filed on 2012/09/19, entitled “Methods, Systems, and Program Products for Locating Tagged Resources in a Resource Scope”; and

Application Ser. No. 13/622,368 (Docket No DRV0021) filed on 2012/09/19, entitled “Methods, Systems, and Program Products for Identifying a Matched Tag Set”.

### BACKGROUND

Tagging has become a common way to allow users to categorize and/or otherwise create relationships between and among resources on the Web. Resources, such as images, video, audio, documents, and other web content are tagged every day. One of the disadvantages of tagging is that it tags often relates more resources than users can manage. Attempts to address this problem have included isolating tags and resources to specific groups for specific purposes and giving tags definitions. These attempts to create the opposite problem by restricting the universe of resources and/or tags. Users of tags need a way to deal with tagged resources in sets with sizes that are useful and manageable but the universe of tagged resources need not be restrained unnecessarily.

Accordingly, there exists a need for methods, systems, and computer program products for navigating tagging contexts.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for navigating tagging contexts. In one aspect, the method includes identifying, in a first tagging context, a first tagging of a first resource with a first tag. The method further includes determining that the first tagging is in a second tagging context. The method still further includes detecting, in the second tagging context and in response to identifying the first tagging, a second tagging, wherein the second tagging is not in the first tagging context. Performing at least one the preceding actions comprising the method includes execution of an instruction by a processor.

Also, a system for navigating tagging contexts is described that includes one or more processors and logic encoded in one or more tangible media for execution by the one or more processors that when executed is operable for identifying, in a first tagging context, a first tagging of a first resource with a first tag; determining that the first tagging is in a second tagging context; and detecting, in the second tagging context and in response to identifying the first tagging, a second tagging, wherein the second tagging is not in the first tagging context.

Further, a system for navigating tagging contexts is described. The system includes a tagging component for identifying, in a first tagging context, a first tagging of a first resource with a first tag. The system further includes a context director component for determining that the first tagging is in a second tagging context. The system still further includes a context navigator component for detecting, in the second tagging context and in response to identifying the first tagging, a second tagging, wherein the second tagging is not in the first tagging context. The system also includes a processor, wherein at least one of the tagging component, the context director component, and the context navigator component includes an instruction that is executed by the processor during operation of the system.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for navigating tagging contexts according to an aspect of the subject matter described herein;

FIG. 3 is a block diagram illustrating an arrangement of components for navigating tagging contexts according to another aspect of the subject matter described herein;

FIG. 4A is a block diagram illustrating an arrangement of components for navigating tagging contexts according to another aspect of the subject matter described herein;

FIG. 4B is a block diagram illustrating an arrangement of components for navigating tagging contexts according to another aspect of the subject matter described herein;

FIG. 4C is a block diagram illustrating an arrangement of components for navigating tagging contexts according to another aspect of the subject matter described herein;

FIG. 4D is a block diagram illustrating an arrangement of components for navigating tagging contexts according to another aspect of the subject matter described herein;

FIG. 5 is a network diagram illustrating a system for navigating tagging contexts according to another aspect of the subject matter described herein;

FIG. 6A is a diagram illustrating a user interface presented via a display according to another aspect of the subject matter described herein;

FIG. 6B is a diagram illustrating a user interface presented via a display according to another aspect of the subject matter described herein;

FIG. 6C is a diagram illustrating a user interface presented via a display according to another aspect of the subject matter described herein;

FIG. 6D is a diagram illustrating a user interface presented via a display according to another aspect of the subject matter described herein; and

FIG. 6E is a diagram illustrating a user interface presented via a display according to another aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure.

Unless otherwise defined, all technical and scientific terms used herein have the same meaning as commonly understood by one of ordinary skill in the art to which this disclosure belongs. Although methods, components, and devices similar or equivalent to those described herein can be used in the practice or testing of the subject matter described herein, suitable methods, components, and devices are described below.

All publications, patent applications, patents, and other references mentioned herein are incorporated by reference in their entirety. In case of conflict, the present specification, including definitions, will control. In addition, the materials, methods, and examples are illustrative only and not intended to be limiting.

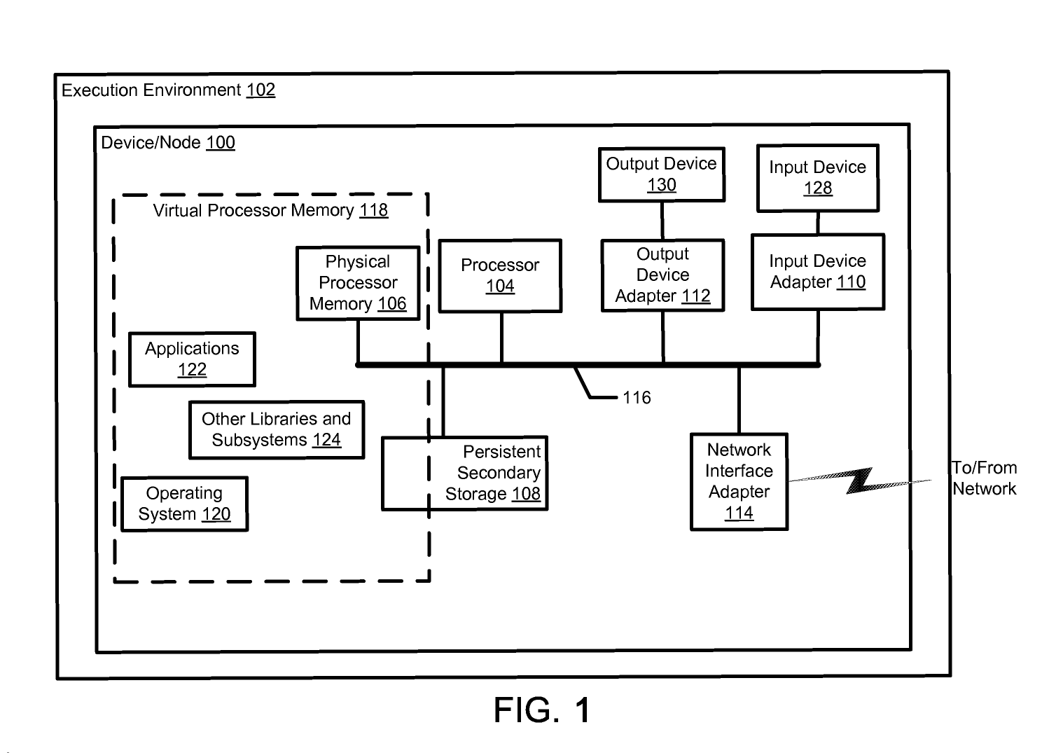

An exemplary device included in an execution environment that may be configured according to the subject matter is illustrated in FIG. 1. An “execution environment”, as used herein, is an arrangement of hardware and, in some aspects, software that may be further configured to include and/or otherwise host an arrangement of components for performing a method of the subject matter described herein. An execution environment includes and/or is otherwise provided by one or more devices. The execution environment is said to be the execution environment of the device and/or devices. An execution environment may be and/or may include a virtual execution environment including software components operating in a host execution environment. Exemplary devices included in and/or otherwise providing suitable execution environments for configuring according to the subject matter include personal computers, notebook computers, tablet computers, servers, portable electronic devices, handheld electronic devices, mobile devices, multiprocessor devices, distributed systems, consumer electronic devices, routers, communication servers, and/or any other suitable devices. Those skilled in the art will understand that the components illustrated in FIG. 1 are exemplary and may vary by particular execution environment.

FIG. 1 illustrates a hardware device 100 included in an execution environment 102. FIG. 1 illustrates that execution environment 102 includes a processor 104, such as one or more microprocessors; a physical processor memory 106 including storage locations identified by addresses in a physical memory address space of processor 104; a persistent secondary storage 108, such as one or more hard drives and/or flash storage media; an input device adapter 110, such as a key or keypad hardware, a keyboard adapter, and/or a mouse adapter; an output device adapter 112, such as a display and/or an audio adapter for presenting information to a user; a network interface component, illustrated by a network interface adapter 114, for communicating via a network such as a LAN and/or WAN; and a communication mechanism that operatively couples elements 104-114, illustrated as a bus 116. Elements 104-114 may be operatively coupled by various means. Bus 116 may comprise any type of bus architecture, including a memory bus, a peripheral bus, a local bus, and/or a switching fabric.

As used herein a “processor” is an instruction execution machine, apparatus, or device. A processor may include one or more electrical, optical, and/or mechanical components that operate in interpreting and executing program instructions. Exemplary processors include one or more microprocessors, digital signal processors (DSPs), graphics processing units, application-specific integrated circuits (ASICs), optical or photonic processors, and/or field programmable gate arrays (FPGAs). Processor 104 may access machine code instructions and data via one or more memory address spaces in addition to the physical memory address space. A memory address space includes addresses identifying locations in a processor memory. The addresses in a memory address space are included in defining a processor memory. Processor 104 may have more than one processor memory. Thus, processor 104 may have more than one memory address space. Processor 104 may access a location in a processor memory by processing an address identifying the location. The processed address may be identified by an operand of a machine code instruction and/or may be identified by a register or other portion of processor 104.

FIG. 1 illustrates a virtual processor memory 118 spanning at least part of physical processor memory 106 and may span at least part of persistent secondary storage 108. Virtual memory addresses in a memory address space may be mapped to physical memory addresses identifying locations in physical processor memory 106. An address space for identifying locations in a virtual processor memory is referred to as a virtual memory address space; its addresses are referred to as virtual memory addresses; and its processor memory is referred to as a virtual processor memory or virtual memory. The term “processor memory” may refer to physical processor memory, such as processor memory 106, and/or may refer to virtual processor memory, such as virtual processor memory 118, depending on the context in which the term is used.

Physical processor memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), RAMBUS DRAM (RDRAM), and/or XDR™ DRAM. Physical processor memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include a removable data storage medium. The drives and their associated tangible computer readable storage media provide volatile and/or nonvolatile storage for computer-readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including an operating system 120, one or more applications 122, and other program code and/or data components illustrated by other libraries and subsystems 124. In an aspect, some or all software components may be stored in locations accessible to processor 104 in a shared memory address space shared by the software components. The software components accessed via the shared memory address space are stored in a shared processor memory defined by the shared memory address space. In another aspect, a first software component may be stored in one or more locations accessed by processor 104 in a first address space and a second software component may be stored in one or more locations accessed by processor 104 in a second address space. The first software component is stored in a first processor memory defined by the first address space and the second software component is stored in a second processor memory defined by the second address space.

Software components typically include instructions executed by processor 104 in a computing context referred to as a “process”. A process may include one or more “threads”. A “thread” includes a sequence of instructions executed by processor 104 in a computing sub-context of a process. The terms “thread” and “process” may be used interchangeably herein when a process includes only one thread.

Execution environment 102 may receive user-provided information via one or more input devices illustrated by an input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by processor 104, physical processor memory 106, and/or other components included in execution environment 102.

An output device 130 in FIG. 1 exemplifies one or more output devices that may be included in and/or that may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user. Sensory information detected by a user is referred herein to as “sensory input” with respect to the user.

A device included in and/or otherwise providing an execution environment may operate in a networked environment communicating with one or more devices via one or more network interface components. The terms “communication interface component” and “network interface component” are used interchangeably herein. FIG. 1 illustrates network interface adapter (NIA) 114 as a network interface component included in execution environment 102 to operatively couple device 100 to a network. A network interface component includes a network interface hardware (NIH) component and optionally a network interface software (NIS) component.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component for operatively coupling the device to a network. Further, the terms “device” and “node” used herein may refer to one or more devices and nodes, respectively, providing and/or otherwise included in an execution environment unless clearly indicated otherwise.

The user-detectable outputs of a user interface are generically referred to herein as “user interface elements” or abbreviated as “UI elements”. More specifically, visual outputs of a user interface are referred to herein as “visual interface elements”. A visual interface element may be a visual output of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the elements listed. Those skilled in the art will understand that this list is not exhaustive. The terms “visual representation”, “visual output”, and “visual interface element” are used interchangeably in this document. Other types of UI elements include audio outputs referred to as “audio interface elements”, tactile outputs referred to as “tactile interface elements”, and the like.

A visual output may be presented in a two-dimensional presentation where a location may be defined in a two-dimensional space having a vertical dimension and a horizontal dimension. A location in a horizontal dimension may be referenced according to an X-axis and a location in a vertical dimension may be referenced according to a Y-axis. In another aspect, a visual output may be presented in a three-dimensional presentation where a location may be defined in a three-dimensional space having a depth dimension in addition to a vertical dimension and a horizontal dimension. A location in a depth dimension may be identified according to a Z-axis. A visual output in a two-dimensional presentation may be presented as if a depth dimension existed allowing the visual output to overlie and/or underlie some or all of another visual output.

A “user interface (UI) element handler” component, as the term is used herein, includes a component of configured to send information representing a program entity for presenting a user-detectable representation of the program entity by an output device, such as a display. A “program entity” is an object included in and/or otherwise processed by an application or executable. The user-detectable representation is presented based on the sent information. Information that represents a program entity for presenting a user detectable representation of the program entity by an output device is referred to herein as “presentation information”. Presentation information may include and/or may otherwise identify data in one or more formats. Exemplary formats include image formats such as raw pixel data, JPEG, video formats such as MP4, markup language data such as hypertext markup language (HTML) and other XML-based markup, a bit map, and/or instructions such as those defined by various script languages, byte code, and/or machine code. For example, a web page received by a user agent from a remote application provider may include HTML, ECMAScript, and/or byte code for presenting one or more UI elements included in a user interface of the remote application. Components configured to send information representing one or more program entities for presenting particular types of output by particular types of output devices include visual interface element handler components, audio interface element handler components, tactile interface element handler components, and the like.

A representation of a program entity may be stored and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space as sensory information for a user. A presentation space may be physically and/or logically contiguous or non-contiguous. A presentation space may have a virtual as well as a physical representation. A presentation space may include a storage location in a processor memory, secondary storage, a memory of an output adapter device, and/or a storage medium of an output device. A screen of a display, for example, is a presentation space.

As used herein, the terms “program” and “executable” refer to any data representation that may be translated into a set of machine code instructions and may optionally include associated program data. The terms are used interchangeably herein. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which this term is used will make clear the state of the object code when it is relevant. This definition can include machine code and virtual machine code, such as Java™ byte code. As used herein, the terms “application”, and “service” may be realized in one or more executables and/or in one or more hardware components. The terms are used interchangeably herein.

As used herein, the term “network protocol” refers to a formal set of rules, conventions and data structures that governs how computers and other network devices exchange information over a network. The rules, conventions, and data structures are said to be specified or defined in a specification and/or schema.

An “interaction”, as the term is used herein, refers to any activity including a user and an object where the object is a source of sensory data detected by the user. In an interaction the user directs attention to the object. An interaction may also include the object as a target of input from the user. The input from the user may be provided intentionally or unintentionally by the user. For example, a rock being held in the hand of a user is a target of input, both tactile and energy input, from the user. A portable electronic device is a type of object. In another example, a user looking at a portable electronic device is receiving sensory data from the portable electronic device whether the device is presenting an output via an output device or not. The user manipulating an input component of the portable electronic device exemplifies the device, as an input target, receiving input from the user. Note that the user in providing input is detecting sensory information from the portable electronic device provided that the user directs sufficient attention to be aware of the sensory information and provided that no disabilities prevent the user from processing the sensory information. An interaction may include an input from the user that is detected and/or otherwise sensed by the device. An interaction may include sensory information that is detected by a user included in the interaction that is presented by an output device included in the interaction.

As used herein “interaction information” refers to any information that identifies an interaction and/or otherwise provides data about an interaction between a user and an object, such as a portable electronic device. Exemplary interaction information may identify a user input for the object, a user-detectable output presented by an output device of the object, a user-detectable attribute of the object, an operation performed by the object in response to a user, an operation performed by the object to present and/or otherwise produce a user-detectable output, and/or a measure of interaction. The term “operational component” of a device, as used herein, refers to a component included in performing an operation by the device.

Interaction information for one object may include and/or otherwise identify interaction information for another object. For example, a motion detector may detect user's head turn in the direction of a display of a portable electronic device. Interaction information identifying the user's head is facing the display may be received and/or used as interaction information for the portable electronic device indicating the user is receiving visual input from the display. The interaction information may serve to indicate a lack of user interaction with one or more other objects in directions from the user different than the detected direction, such as a person approaching the user from behind the user. Thus the interaction information may serve as interaction information for one or more different objects.

The term “attention information” as used herein refers to information that identifies an attention output and/or that includes an indication to present an attention output. Attention information may identify and/or may include presentation information that includes a representation of an attention output, in one aspect. In another aspect, attention output may include a request and/or one or more instructions for processing by a processor to present an attention output. The aspects described serve merely as examples based on the definition of attention information, and do not provide an exhaustive list of suitable forms and content of attention information.

As used herein the term “attention criterion” refers to a criterion that when met is defined as indicating that interaction between a user and an object is or maybe inadequate at a particular time and/or during a particular time period. In other words, the user is not directing adequate attention to the object.

As used herein, the term “tag” refers to a character string, which may include one or more words, which may be associated with a resource to create an association between the resource and another resource also tagged with the tag. Tags are often used in sharing media, social bookmarking, social news and blog entries to help users search for associated content. In some contexts, the term “tagging” as used herein refers to the process of associating a tag with a resource that can be tagged. As used herein, the term “tagged association” refers to an association that identifies a tag and a resource that is tagged with the tag. A resource is said to be “tagged” with a tag when a tagging process, also referred to as “tagging”, has successfully created a tagged association. In other contexts, a “tagging” refers to a tagged association.

The term “matched tag”, as used herein, refers to an association that identifies a tag and a tagging criterion, where the tagging criterion is based on data other than the tag. The tagging criterion may be based additionally on the tag. The term “tagging association”, as used herein, refers to a matched tag represented in a memory, either persistent and/or volatile. For example, a tagging association may be realized as a record that includes and/or identifies a tag and a tagging criterion. The terms “matched tag” and “tagging association” are used interchangeably. When the term “matched tag” refers to something other than its tagging association, it will be made clear. For example, a reference to matched tag presented in a user interface clearly identifies a UI element that identifies and/or otherwise represents and/or otherwise identifies a matched tag either realized or to be realized in a tagging association. A tagged association, defined above, may identify a matched tag and a resource that is tagged with the tag identified by the matched tag. Such an association is also referred to herein as a “matched tag association”. A resource may be tagged with a matched tag when a tagging criterion identified by the matched tag is met for the resource.

As user herein, the term “vocabulary” refers to a set of valid values that can be assigned to and/or included in a data element. With respect to a tag, a vocabulary defines valid tags. A vocabulary may be specified by one or more rules and/or by identifying one or more valid values directly and/or indirectly.

As used herein, the term “dictionary” refers a vocabulary wherein one or more terms in the vocabulary is assigned a definition. A “definition” as the term is used herein refers to information that identifies semantic information about a data value, such as at tag. Semantic information may include one or more of a textual description of a meaning of the term, an audio description, a visual description, and information identifying a use or context for the term. A use and/or context may be identified, for example, by identifying a part of speech, a dialect or language, an antonym, a synonym, and/or an example usage of the defined data value.

As used herein, any reference to an entity “in” an association is equivalent to describing the object as “identified” by the association, unless explicitly indicated otherwise.

As used herein, the term “communication” refers to information including a message sent and/or for sending via a network between communicants. A message may include text data, audio data, and/or image data. The term “communicant” as used herein refers to a user included in a communication as a sender and/or a receiver of the information. A communicant is represented by a “communications agent” configured to operate in an execution environment to send data to and/or receive data from another communications agent, on behalf of the represented communicant, according to a communications protocol via network. A communications protocol defines and/or otherwise identifies an address space including communications addresses for delivering data sent in a communication from one communications agent to another. A communications protocol is a type of network protocol.

The term “communicant alias” as used herein refers to an identifier of a communicant in a communication where the communicant alias is not a communications address included in an address space of a communications protocol for sending and/or receiving data in the communication.

The term “attachment” as used herein refers to a portion of a communication that includes data from one communicant to another other than data in the message portion. A resource sent as an attachment is data that is typically not presented “inline” or in a message included in a message portion of a communication. Email attachments are perhaps the most widely known attachments included in communications. An email attachment is a file or other resource sent along with an email in a portion of the email separate from a message portion. A communication may include one or more resources as one or more attachments.

The terms “contactor” and “contactee” identify roles in a communication. A “contactor” provides information for identifying a “contactee” in a communication. A contactee may be included in a communication by a contactor and/or the contactor's communications agent. A contactor and/or a contactee are roles of a user or communicant of a communications agent and may be a living being, a node, a component, and/or an application. Both a contactor and a contactee are communicants in a communication.

As used here, the term “tagging-attribute association” refers to an association that identifies one or more tagging criterion and a resource attribute that the one or more tagging criterion are each based on. That is, whether a tagging criterion identified in a tagging-attribute association is met for a specified resource depends on an attribute of the resource identified by the tagging-attribute association. The term attribute, as used herein, includes the resource, as a resource is considered to be an attribute of itself and/or otherwise to include at least some of its attributes.

As used herein, the term “resource scope” refers a bounded space in which a resource may be identified. The space may be any space in which a resource may be locate and/or otherwise identified. A bounded may be may include one or more of an identifier space such as file system identifier space and/or a URI address space, a storage space, a geospatial space, a demographic space, and a data type—to name a few examples. space, defines a set of resources from which resources may be identified. For example, the files within a specified folder and its subfolders in a file system define and/or otherwise specify a resource scope. All user accounts that have an administrator security role define another resource scope. The present disclosure describes a resource scope with respect to resources tagged with a specified tag that makeup a set, referred to herein as a “tagged resource set”. A tagged resource set may include a resource tagged with a tag identified by a matched tag.

In specifying a resource scope, one or more criterion may be specified. The terms “criterion” and “constraint” are used interchangeably herein, with respect to a resource scope. A criterion included in specifying a resource scope is referred to herein as a “scope criterion”. A scope criterion may be expressed via any suitable manner, such as a file name, a wildcard expression, a regular expression, a data store location, a data base query, geospatial coordinates, a time, a date, a duration, a relationship to a user, and/or an address—too name a few examples. With respect to a tag, a scope criterion included in defining a resource scope differs from a tagging criterion for the tag in that the scope criterion included in defining a resource scope need not be met in order for a resource to be tagged with the tag. Further a resource scope may be used for purposes other than processing related to a tagged resource.

One or more scope criterion that together specify and/or otherwise define a resource scope is/are referred to herein as a “scope descriptor”. When all the criteria in a scope descriptor are met for a resource, the resource is in the resource scope defined by the scope descriptor. The one or more separate criterion in a scope descriptor may be evaluated in any order suitable or desirable in any given embodiment. In an aspect described below, one scope criterion, that may be included in a scope descriptor, may be specified to determine and/or otherwise identify when the scope descriptor is “active”. A scope criterion that indicates whether a scope descriptor is active is referred to herein as a “scope condition”. In a further aspect a scope descriptor may include no other criterion indicating the resource scope includes all resources accessible to an application, subsystem, execution environment, and/or group of any of the preceding that are processing and/or otherwise making use of the scope descriptor. Those skilled in the art will understand that whether a scope criterion in a scope descriptor is called a scope condition or not depends on the role played by the scope criterion. The subject matter may be described without referring to a scope criterion in the role of a scope condition without limiting the scope of subject matter.

Although, those skilled in the art will know that a scope criterion may be defined as “met” when it is true or may be defined as “met” when it is not true; for purposes of the present disclosure, A scope criterion is said to be “met” for a resource when it indicates the resource is in the resource scope defined by the scope descriptor, and is to be “not met” otherwise. A scope criterion in the role of a scope condition in a scope descriptor is said to be “met” when it indicates the scope descriptor is active, as is said to be “not met” otherwise. In an aspect, a scope descriptor may not include a scope condition or may include a scope condition that is always met. Such a scope descriptor is active by definition. Whether a criterion, in a scope descriptor is met or is not met, may depend on an evaluation of the scope criterion that is based on an identifiable entity. For a scope condition, such an entity is referred to herein as a “condition entity”. More generally, for a scope criterion, such an entity is referred to herein as a “scoping entity”. Exemplary entities include a user, a document, a measure of time, a location, and the like.

An association between a tag and scope descriptor is referred to herein as a “scoped tag”. A scoped tag is also referred to herein as a match set. As defined above, a tagging criterion may be used to determine whether to tag a particular resource with a particular tag. The tagging criterion is associated with the tag by a matched tag. A scope descriptor identifies resource scope that includes a set of resources. Scope descriptors are necessarily associated with resources.

A “tagging context”, as the term is used herein, identifies and/or otherwise includes a set of tagged associations or taggings. The taggings may identify one or more tags and one or more resources. A “tagging context specification”, as the term is used herein, is data that defines and/or otherwise specifies a tagging context. A tagging context specification may be stored in a memory location. The memory location may be contiguous or not and may be included in one or more data storage media, which may be volatile or not. A tagging context specification may include and/or otherwise identify any suitable criterion, referred to in general as “context criterion”, for determining whether a tagging is in a tagging context defined by the tagging context specification. For example, a tag contact specification may identify one or more scope descriptors, one or more tags some or all of which may be and/or may be identified by matched tags, and a context condition; all of which are context criterion by definition.

A “context condition”, as the term is used herein, refers to a context criterion that when met indicates that a tagging context is active for one or more taggings. When a context condition is not met, it is said to be inactive or not active for one or more taggings. For example, a context condition in a tagging context specification may be met for a first user. Taggings in the tagging context are “active” for the first user. For a second user, the context condition may not be met. The taggings are not active for the second user. A context condition, or more generally a context criterion, may be based on any suitable data for any suitable entity. A tagging context may be active for a task and not for another and/or a tagging context may be active for one location and not for another, to name a couple of other examples. When a context condition indicates that an associated tagging context is active for a tag, the context condition is herein said to be “met”, otherwise the context condition is not met.

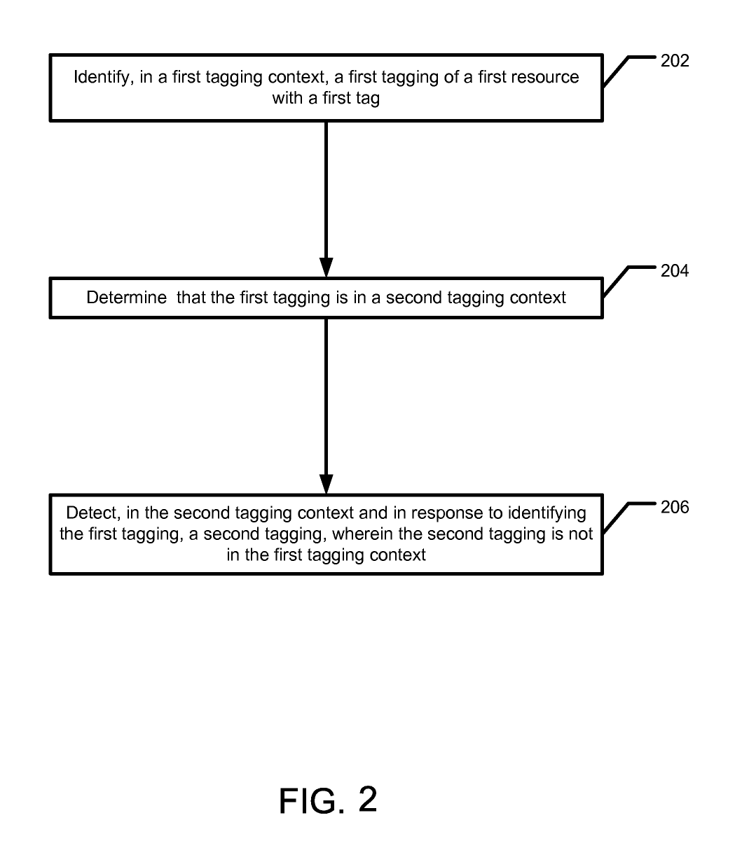

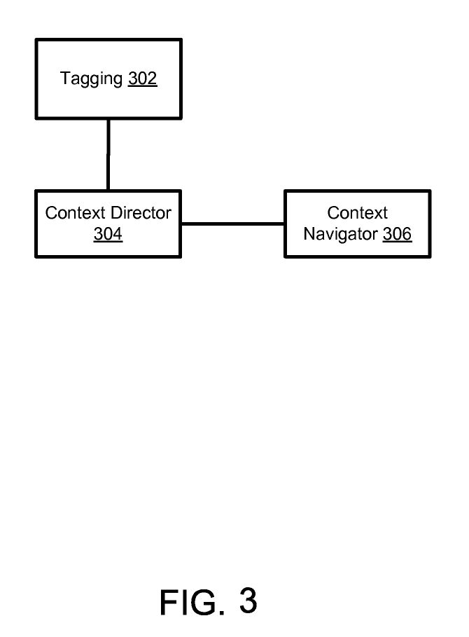

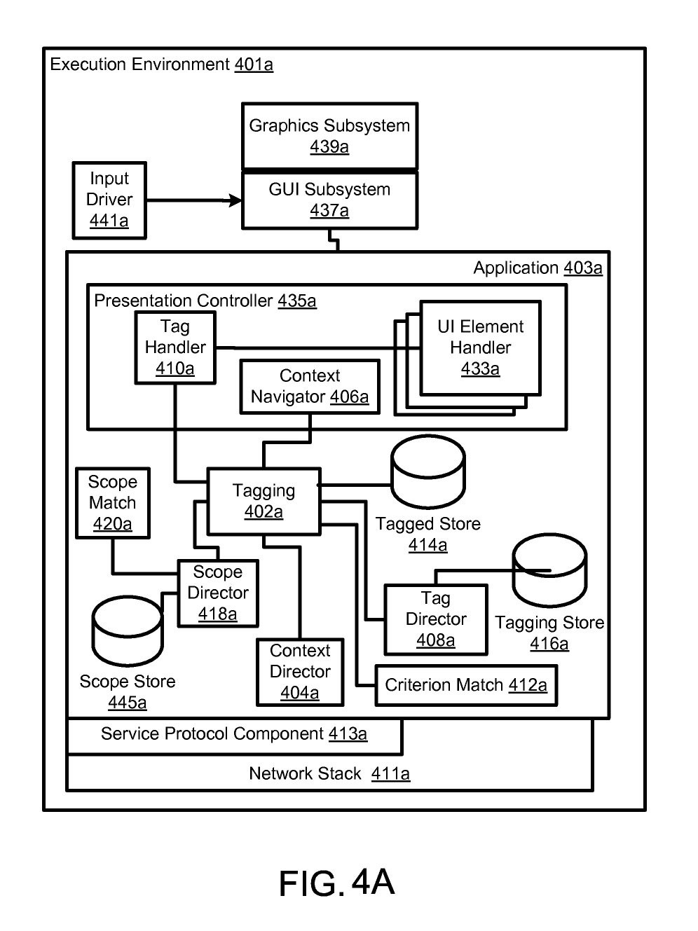

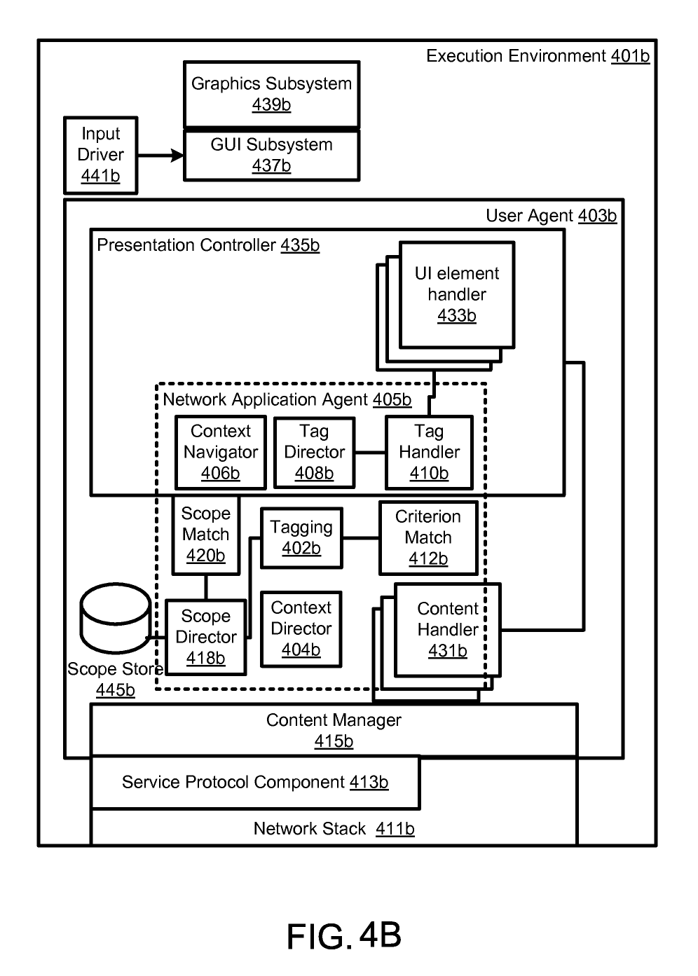

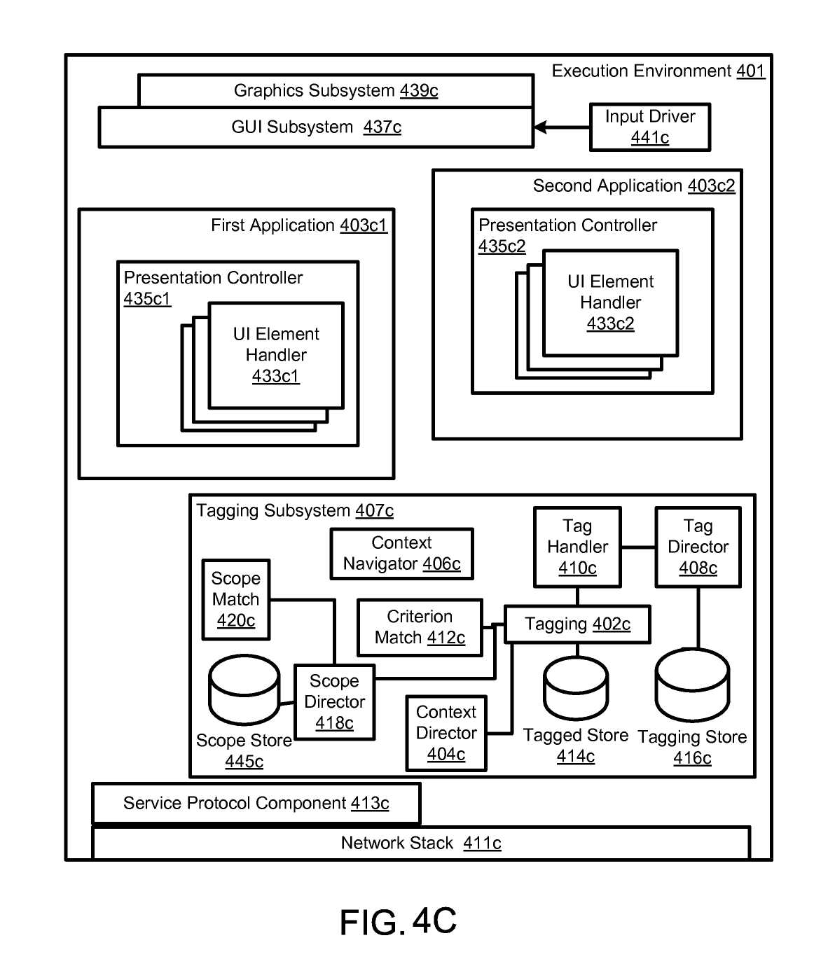

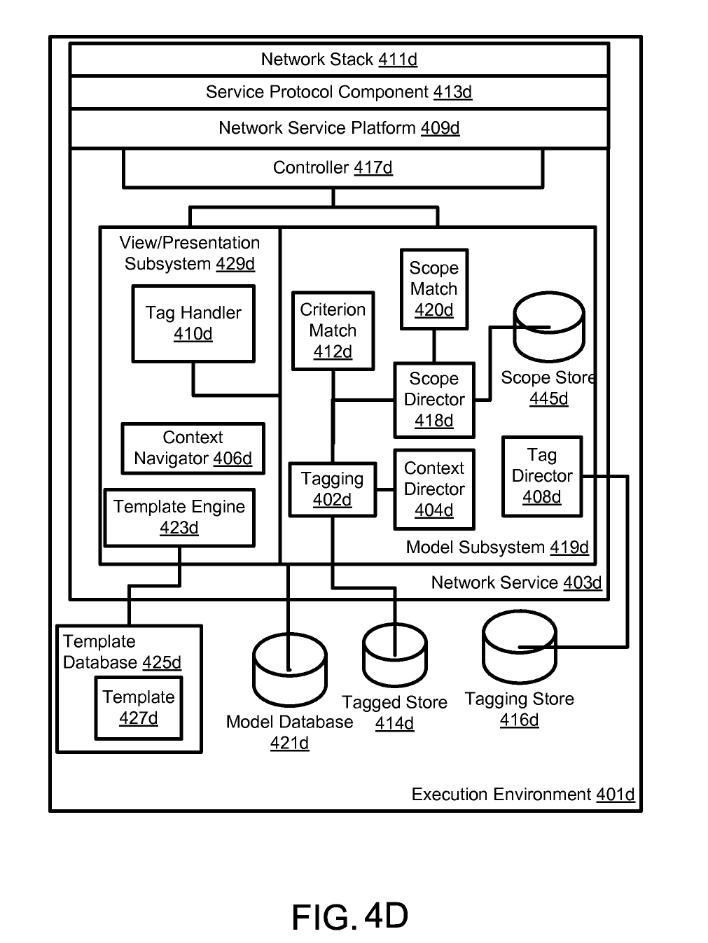

The block diagram in FIG. 3 illustrates an exemplary system for navigating tagging contexts according to the method illustrated in FIG. 2. FIG. 3 illustrates a system, adapted to operate in an execution environment, such as execution environment 102 in FIG. 1, to perform the method illustrated in FIG. 2. The system illustrated includes a tagging component 302, a context director component 304, and a context navigator component 306. The execution environment includes a processor, such as processor 104, for processing an instruction in at least one of the tagging component 302, the context director component 304, and the context navigator component 306. Some or all of the exemplary components illustrated in FIG. 3 may be adapted to operate in a number of execution environments to performing the method illustrated in FIG. 2. FIGS. 4A-D are each block diagrams illustrating the components of FIG. 3 and/or analogs of the components of FIG. 3 respectively adapted for operation in execution environment 401a, execution environment 401b, execution environment 401c, and execution environment 401d that each include and/or otherwise are provided by one or more nodes. Components, illustrated in FIG. 4A, FIG. 4B, FIG. 4C and FIG. 4D, are identified by numbers with an alphabetic character postfix. Execution environments; such as execution environment 401a, execution environment 401b, execution environment 401c, execution environment 401d, and their adaptations and analogs; are referred to herein generically as execution environment 401 or execution environments 401 when describing more than one. Other components identified with an alphabetic postfix may be referred to generically or as a group in a similar manner.

FIG. 1 illustrates key components of an exemplary device that may at least partially provide and/or otherwise be included in an execution environment. The components illustrated in FIG. 4A, FIG. 4B, FIG. 4C, and FIG. 4D may be included in or otherwise combined with the components of FIG. 1 to create a variety of arrangements of components according to the subject matter described herein.

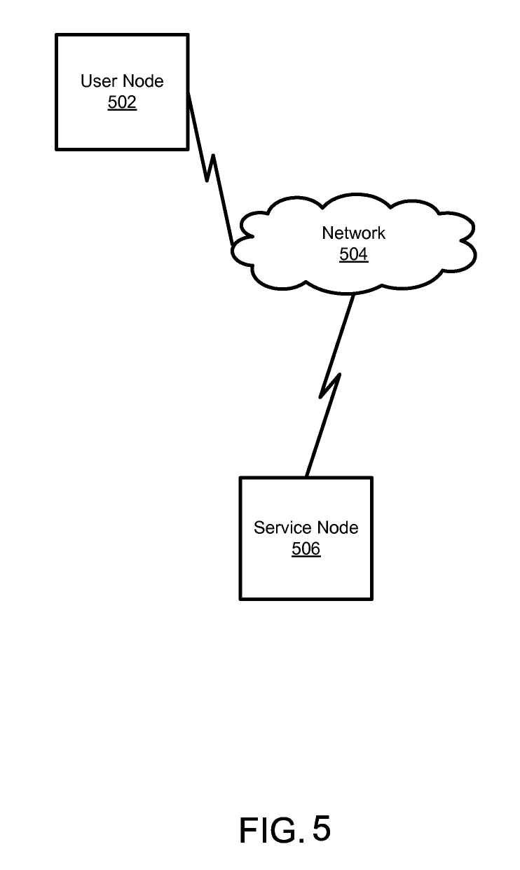

FIG. 5 illustrates user node 502 as an exemplary device that in various aspects may be included in and/or otherwise adapted for providing any of execution environments 401 illustrated in FIGS. 4A-C each illustrating a different adaptation of the arrangement of components in FIG. 3. As illustrated in FIG. 5, user node 502 is operatively coupled to network 504 via a network interface component, such as network interface adapter 114. Alternatively or additionally, an adaptation of an execution environment 401 may include and/or may otherwise be provided by a device that is not operatively coupled to a network. A server device is illustrated by service node 506. Service node 506 may be included in and/or otherwise adapted for providing execution environment 401d illustrated in FIG. 4D. As illustrated in FIG. 5, service node 506 is operatively coupled to network 504 via a network interface component included in execution environment 401d.

FIG. 4A illustrates that execution environment 401a hosts an application 403a that includes an adaptation of the arrangement of components in FIG. 3. FIG. 4B illustrates execution environment 401b hosting a user agent 403b, such as web browser, including an adaptation of the arrangement of components in FIG. 3 that may operate at least partially in a network application agent 405b received from a remote application provider, such as a network service 403d in FIG. 4D. User agent 403b and execution environment 401b may provide at least part of an execution environment for network application agent 405b that may be received via network 504 from network service 403d operating in service node 506. FIG. 4C illustrates an arrangement of the components in FIG. 3 adapted to operate in a tagging subsystem 407c of execution environment 401c. The arrangement in FIG. 4C may mediate communication between applications 403c and one or more output devices, such as output device 130 in FIG. 1. FIG. 4D illustrates execution environment 401d hosting one or more network services, such as a web application, illustrated by network service 403d. FIG. 4D also illustrates a network service platform 409d that may provide services to one or more network services. Network service 403d includes yet another adaptation of the arrangement of components in FIG. 3.

As stated the various adaptations of the arrangement in FIG. 3 are not exhaustive. For example, those skilled in the art will see based on the description herein that arrangements of components for performing the method illustrated in FIG. 2 may operate in a single device, or may be distributed across more than one node in a network and/or more than one execution environment. For example, such an arrangement may operate at least partially in user agent 403b illustrated in FIG. 4B and at least partially in execution environment 401d in and/or external to network service 403d.

FIGS. 4A-D illustrate network stacks 411 that operate to send and receive data over network 504, via a network interface component. Network service platform 409d in FIG. 4D provides services to one or more network services. In various aspects, network service platform 409d may include and/or interoperate with a web server. FIG. 4D also illustrates network service platform 409d that interoperates with a network stack 411d. Interoperating network stacks 411 may support the same protocol suite, such as TCP/IP, or may communicate via a network gateway or other protocol translation device and/or service. For example, user agent 403b in FIG. 4B and network service platform 409d in FIG. 4D may interoperate via their respective network stacks: a network stack 411b and network stack 411d.

FIGS. 4A-D illustrate applications 403, respectively, which may communicate via one or more service protocols. FIGS. 4A-D respectively illustrate service protocol components 413 that operate to communicate via one or more service protocols. Exemplary service protocols include hypertext transfer protocol (HTTP), remote procedure call (RPC) protocols, instant messaging protocols, and presence protocols. Matching protocols enabling applications 403 to communicate via network 504 in FIG. 5 are not required, if communication is via a protocol gateway or other translator.

FIG. 4B illustrates that a user agent may receive some or all of a network application agent in one or more messages sent from a network service, such as network service 403d, via a network service platform 409, a network stack 411, a network interface component, and optionally a service protocol component 413. In FIG. 4B, user agent 403b includes a content manager component 415b. Content manager component 415b may interoperate with one or more of service protocol components 413b and/or network stack 411b to receive the message or messages including some or all of a network application agent 405.

A network application agent 405 may include and/or otherwise may provide access to a web page for presenting a user interface for and/or otherwise based on data from a corresponding network service. The web page may include and/or reference data represented in one or more formats including hypertext markup language (HTML) and/or another markup language, ECMAScript and/or other scripting language, byte code, image data, audio data, and/or machine code.

In an example, in response to a request received from user agent 403b, a controller component 417d, in FIG. 4D, may invoke a model subsystem 419d to perform request-specific processing. Model subsystem 419d may include any number of request handlers (not shown) that operate to dynamically generate data and/or to retrieve data from a model database 421d based on the request. Controller component 417d may further invoke a template engine component 423d to identify one or more templates and/or static data elements to generate a user interface to present a response to the received request. FIG. 4D illustrates a template database 425d including one or more templates illustrated by template 427d. FIG. 4D illustrates template engine component 425d as a component in a view subsystem 429d that operates to return responses to processed requests in a presentation format suitable for a client, such as user agent 403b. View subsystem 429d may provide the presentation data to controller component 417d to send to user agent 403b in response to the request received from user agent 403b. Some or all of a network application agent may be sent to a user agent via a network service platform, as described above.

While the example describes sending some or all of a network application agent in response to a request, network service 403d additionally or alternatively may send some or all of network application agent 405b to user agent 403b via one or more asynchronous messages. In an aspect, an asynchronous message may be sent in response to a change detected by network service 403d. Publish-subscribe protocols, such as the presence protocol specified by XMPP-IM, are exemplary protocols for sending messages asynchronously.

The one or more messages including information representing some or all of network application agent 405b illustrated in FIG. 4B may be received by content manager component 415b via one or more of service protocol component(s) 413b and network stack 411b as described above. In FIG. 4B, user agent 403b includes one or more content handler components 431b to process received data according to its data type, typically identified by a MIME-type identifier. Exemplary content handler components 431b include a text/html content handler component for processing HTML documents; an application/xmpp-xml content handler component for processing XMPP streams including presence tuples, instant messages, and publish-subscribe data as defined by various XMPP specifications; one or more video content handler components for processing video streams of various types; and still image data content handler components for processing various images types. Content handler components 431b process received data and may provide a representation of the processed data to one or more user interface (UI) element handler components 433b.

UI element handler components 433 are respectively illustrated in presentation controller components 435 in FIGS. 4A-C. A presentation controller component 435 may manage visual, audio, and/or other types of output of its including application 403 as well as receive and route detected user and other inputs to components and extensions of its including application 403. With respect to FIG. 4B, a UI element handler component 433b in various aspects may be adapted to operate at least partially in a content handler component 431b such as a text/html content handler component and/or a script content handler component. Additionally or alternatively, a UI element handler component 433 in an execution environment 401 may operate in and/or as an extension of its including application 403. For example, a plug-in may provide a virtual machine, for a UI element handler component 433 received as a script and/or byte code, that may operate as an extension in an application 403 and/or external to and interoperating with the application 403.

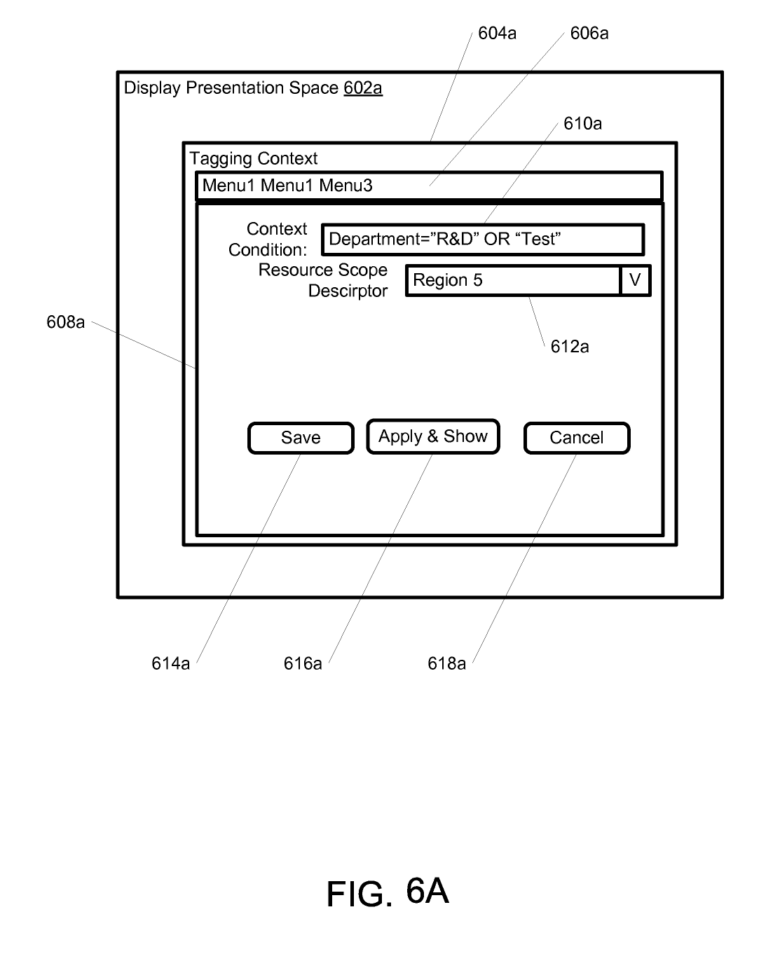

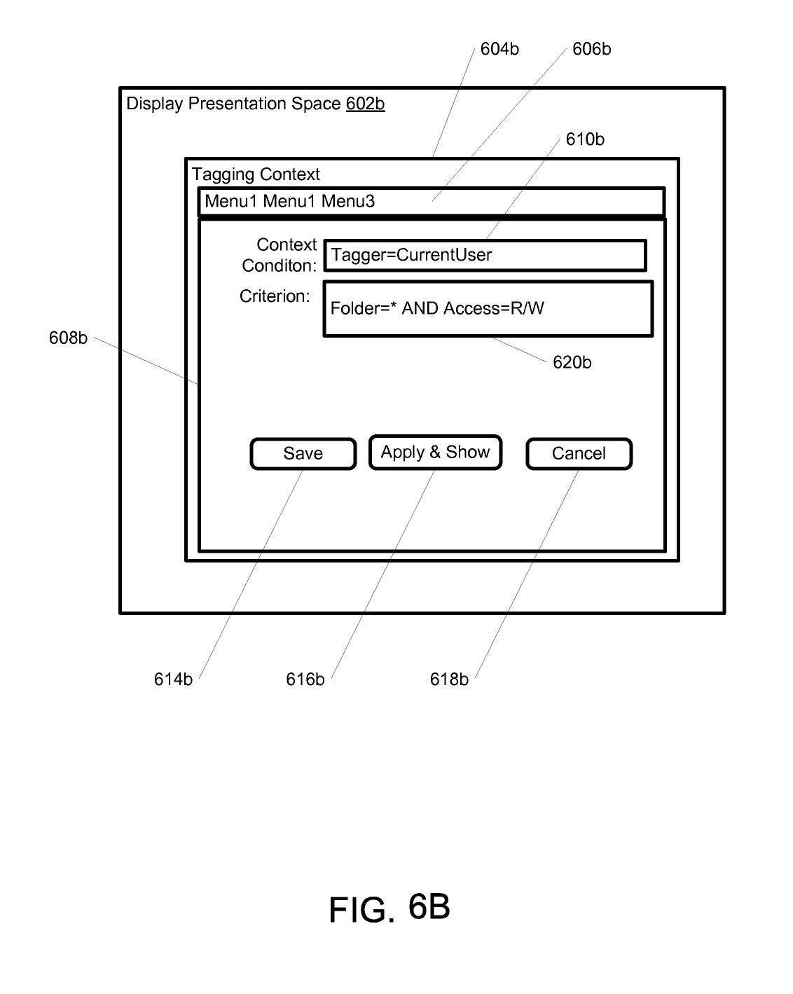

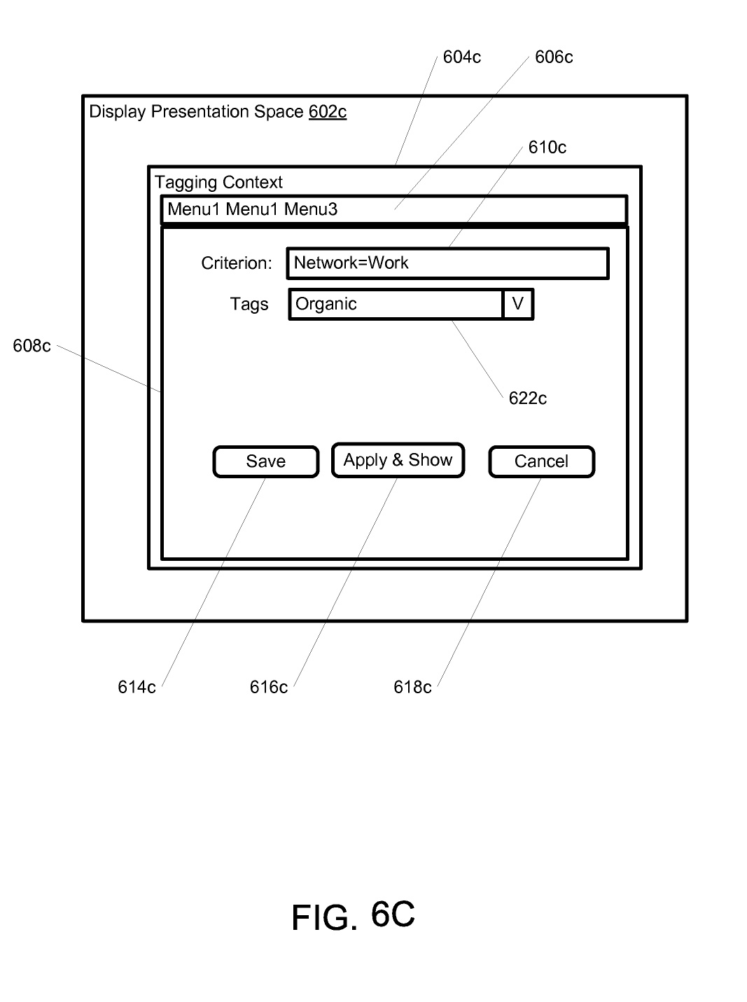

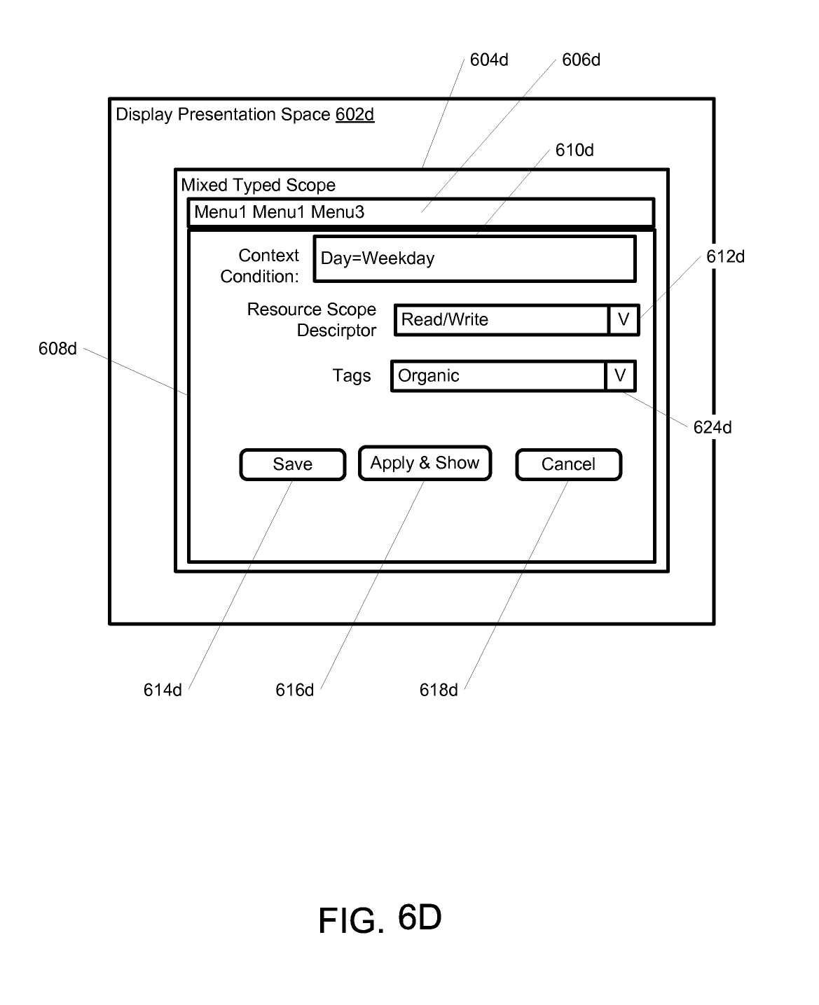

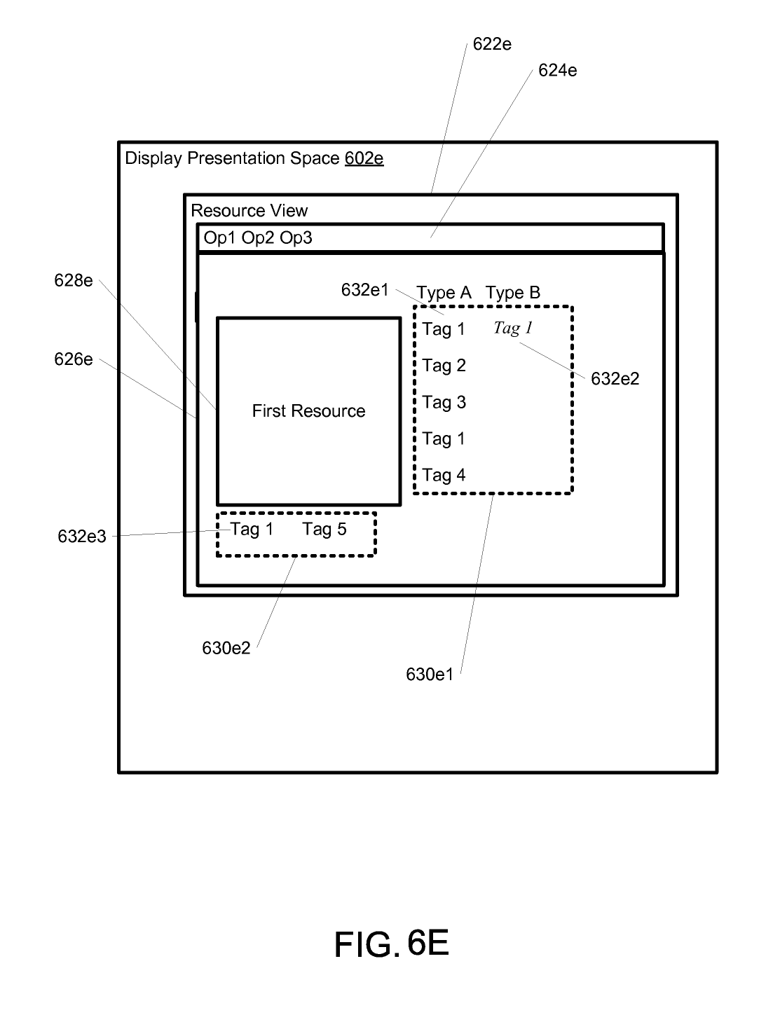

FIGS. 6A-E each respectively illustrates a display presentation space 602 of a display in and/or operatively coupled to node, such as user node 502. FIGS. 6A-E each respectively illustrates various UI elements presented that may provide and/or be included in a user interface for any of applications 403 illustrated in FIGS. 4A-D and/or by a network application agent. For example, a UI element in a user interface may be presented via interoperation of user agent 403b, network application agent 405b, and/or network service 403d. A user agent window may include a user interface of network service 403d operating in execution environment 401d of service node 506.

Various UI elements of applications 403 described above may be presented by one or more UI element handler components 433 in FIGS. 4A-C and/or by view subsystem 429d as illustrated in FIG. 4D. In an aspect, illustrated in FIGS. 4A-C, a UI element handler component 433 of one or more applications 403 may operate to send presentation information representing a UI element, such as any of the visual components presented in display presentation spaces 602 in FIGS. 6A-D, to a GUI subsystem 437. The GUI subsystem 437 may instruct a graphics subsystem 439 to draw the UI element in a region of a display presentation space 602, based on presentation information received from the corresponding UI element handler component 433.

User input may be received corresponding to a UI element via an input driver 441 illustrated in FIGS. 4A-C, in various adaptations. For example, a user may move a mouse to move a pointer presented in a display presentation space 602 over a UI element. A user may provide an input detected by the mouse. The detected input may be received by a GUI subsystem 437 via an input driver 441 as an operation or command indicator based on the association of the shared location of the pointer and the UI element in the display presentation space 602.

A tag and/or a matched tag may be created in response to user input. In various aspects, a tag director component 408 may receive tagging information based on input information from a UI element handler component 433. A user input may be detected that corresponds to a UI element presented for identifying a tag. A tag may be a user entered tag and/or otherwise a user selected tag. For a matched tag, criterion information identifying a tagging criterion may be received via the same or different UI element handler component 433, where the tagging criterion is based on something other than and/or in addition to the identified tag. In another aspect, a tagging criterion may be determined based on a user identified tag, by a UI element handler component 433 and/or by a tag director component 408, in response to a user detected input identifying the tag. The tag director component 408 may create a “matched tag” by creating a tagging association that identifies the tag and the tagging criterion. A tag director component 408 may create a “tag” by creating an entry in an index and/or in a vocabulary of tags. The tag director component 408 may store the tag and/or tagging association in any suitable memory locations, such a storage system illustrated by a tagging store 416. A tagging store may be included in and/or my include some or all of a database, a file system, a disk I/O system, and/or a structure in a processor memory, to name some examples.

Reference is made, herein, to a tagging context defined above. FIGS. 6A-D illustrated input specifying various tagging contexts. With reference to FIG. 2, the method may include creating a tagging context. Accordingly, a system may include means for creating a tagging context and/or a scope descriptor. FIGS. 4A-D illustrate context director components 404 for creating, removing, maintaining, and/or otherwise accessing a tagging context, in various aspects A system may include one or more processors and logic encoded in one or more tangible media for execution by the one or more processors that when executed is operable for creating, removing, maintaining, and/or otherwise accessing a tagging context, in various aspects.

FIG. 6A-D depict user interfaces for receiving user input to specify tagging contexts. The user interfaces in various aspects may be, presented by one or applications 403 as described above for any of FIGS. 4A-D. An application 403 includes one or more UI element handlers 433 to present a tagging context UI element 604 in a presentation space 602 of a display device. Tagging context UI elements 604 are illustrated with a menu bar UI element 606 including input UI elements for receiving user input for various specified operations. Tagging context UI elements 604 respectively illustrate input pane UI elements 608 to prompt a user to provide corresponding input to specify condition information to specify a context condition via a context condition UI element 610. In FIG. 6A, a descriptor UI element 612 is presented by a corresponding UI element handler component 433a allowing corresponding user input that identifies a scope descriptor to be received and/or otherwise detected.

In various aspects, a context director component 404 may receive context condition information based on input information from a UI element handler component 433. In FIGS. 6A-D a UI element handler component corresponding to a context condition UI element, such as context condition UI element 610a in FIG. 6A may receive “Department=R&D OR Test” specifying that when the specified tagging context is active for users who are in an R&D department and/or a Test department. That is, for such users, the specified tagging context identifies taggings for those users. Such users may not see or otherwise have access to other taggings via the specified context. An associated scope descriptor further refines the taggings to those that tag resources in a scope descriptor assigned the identifier “Region 5”. In an aspect, region 5 may identify one or more buildings of a corporate site, a region of a country, or any other suitable scope descriptor. A user input may be detected that corresponds a UI element presented to identify and/or otherwise represent a scope descriptor such as scope descriptor UI element 612a in FIG. 6A. Context condition information and/or scope descriptor information may be user entered and/or otherwise user selected. Further, scope descriptor information identifying a scope descriptor may be received via the same or different UI element handler component 433 which receives the context condition information. In creating and/or otherwise identifying a tagging context, a context director component 404 may create and/or represent a tagging context in a memory that identifies a context criterion, such as context condition, a scope descriptor, and/or a tag which may be a matched tag.

In an execution environment 401, such as execution environment 401a in FIG. 4A, which may be included in and/or otherwise may include a node, such as user node 502 illustrated in FIG. 5. Context criterion information identifying a context criterion may be received by a UI element handler component 433a in response to a user input detected by an input driver 441a. Input information, such as information identifying a location in a presentation space of a display, may be provided by the input driver 441a to GUI subsystem 437a. Based on the input information, GUI subsystem 437a may identify application 403a and send the input information, to application 403a. GUI subsystem 437a may provide a component, such as presentation controller 435a that operates to route input information within application 403a to a UI element handler component 433a. The UI element handler component 433a may identify the context criterion information based on the input information and may provide the context criterion information to context director component 404a. Alternatively or additionally, GUI subsystem 437a may provide input information directly to one or more UI element handlers 433a corresponding to one or more UI elements that GUI subsystem 437a has determined correspond to the detected user input. Context criterion information such as scope descriptor information identifying a scope criterion may be received in an analogous manner via the same or different UI element handler component 433a. The UI element handler component 433a may identify the context criterion information based on the input information and provide the other context criterion information to context director component 404a. Context director component 404a may specify and/or otherwise define a tagging context by creating a record and/or otherwise associating data that identifies the context criterion and the other context criterion information such as a scope descriptor, one or more tags, and/or other criterion. The one or more tags may include one or more matched tags. The tagging context specification may be stored in any suitable storage medium.

An arrangement of components in execution environment 401b illustrated in FIG. 4B, may operate to perform equivalently in creating a tagging context. Execution environment 401b may also include and/or otherwise be included in a node, such as a user node 502 illustrated in FIG. 5. In FIG. 4B, a UI element handler component 433b and/or a presentation controller component 435b may receive input information corresponding to a presented user interface element for identifying context condition information and/or other context criterion information. The input information may be provided to the UI element hander component 433b for processing. The UI element handler component 433b may perform all or some of the processing and/or may send a request to a remote service, such as network service 403d operating in execution environment 401d of a service node 506, via a network, such as network 504. Some or all of the processing of the input information may be performed in execution environment 401d to identify and/or otherwise determine context condition information identifying a context condition. Other context specification such as a context criterion and/or a matched tag may be identified and/or otherwise determined analogously. One or more UI element handler components 433b and/or UI element handler components 433d may provide context condition information and other context criterion information to one or both of context director component 404b operating in execution environment 401b and/or to context director component 404d in execution environment 401d to create a tagging context specification.

FIG. 4D illustrates, in an aspect, context director component 404d in a model subsystem 419d in execution environment 401d which may be included in and/or otherwise may include service node 506 in FIG. 5. A UI element handler component 433b for presenting and/or receiving input identifying context condition information and/or a UI element handler component 433b for presenting and/or for receiving input identifying other context criterion information may operate in user agent 403b in execution environment of user node 502. A message based on the input information corresponding to a UI element presented by the context condition information UI element handler component 433b and/or one or more other context criterion information UI element handler components 433b may be transmitted by user agent 403b to network service 403d operating in execution environment 401d of service node 506 via network 504. Context director component 404d may be invoked in response to the message by a request handler (not shown) in model subsystem 419d. Context director component 404d may receive context condition information and/or otherwise may identify context condition information based on the message. User agent 403b and/or network application agent 405b may send the message via user node 502 communicatively coupled to network 504 to service node 506 for delivery to network service 403d. Controller component 417d may receive at least some portion of the message. Based on the message or portion thereof, such as a URI, controller component 417d may route information in the message to a request handler (not shown) in model subsystem 419d. Context director component 404d may include, may be included in, and/or may otherwise interoperate with the request handler identified by controller component 417d. Context director component 404d may identify a context condition based on the context condition information received and/or otherwise identified. Context director component 404d may identify other context criterion information analogously, based on input detected by user agent 403b in execution environment 401b of user node 502. Context director component 404d may create a tagging context specification identifying the context condition and any other context criterion information. For example, in an aspect, context director component 404d may store a tagging context specification in one or more records and/or locations in a data base and/or a file system.

The arrangement of components operating in execution environment 401c, illustrated in FIG. 4C, may also perform the operations described above and/or analogous operations. Execution environment 401c and/or analog of execution environment 401c may be provided by and/or otherwise may include one or more nodes, such as a user node 502. Input processing in execution environment 401c in FIG. 4C may be performed for more than one application 403c by a subsystem illustrated by tagging subsystem 407c. In an aspect, a UI element handler component 433c and/or a presentation controller component 435c operating in an application 403c may receive input information corresponding to a presented item to identify context condition information and/or to identify other context criterion information such as one or more tags. The UI element handler component 433c may operate in an application, such a first application 403c1 or a second application 403c2 as shown in FIG. 4C. Alternatively or additionally, an application 403c may interoperate with a UI element handler component, provided by tagging subsystem 407c. A UI element handler 433c1 in first application 403c1 may interoperate with a UI element handler component in tagging subsystem 407c in receiving input information to provide context condition information and/or other context criterion information to context director component 404c. A user input may be detected by an input driver 441c. Input information, such as information identifying a location with respect to a presentation space, may be provided by the input driver 441c to a GUI subsystem 437c. Based on the input information, GUI subsystem 437c may identify an application 403c and send selection information, based on the input information, to the application 403c. GUI subsystem 437c may provide input information to a component, such as a presentation controller 435c1 to route the input information within first application 403c1 for processing. Alternatively or additionally, GUI subsystem 437c may provide input information directly to one or more UI element handlers 433c corresponding to one or more UI elements that GUI subsystem 437c determines correspond to the detected user input. Context director component 404c creates a tagging context specification identifying the context condition and/or the other context criterion information. For example, in an aspect, scope director component 418d may store a scope descriptor to realize and/or otherwise represent the scope descriptor in a storage location in a processor memory and/or in a persistent secondary storage location in scope store 445c.

With reference to FIG. 2, a block 202 illustrates that the method includes identifying, in a first tagging context, a first tagging of a first resource with a first tag. Accordingly, a system for navigating tagging contexts includes means for identifying, in a first tagging context, a first tagging of a first resource with a first tag. For example, the arrangement in FIG. 3, includes tagging component 302 that is operable for identifying, in a first tagging context, a first tagging of a first resource with a first tag. FIGS. 4A-D illustrate tagging components 402 as adaptations and/or analogs of the tagging component 302 in FIG. 3. One or more tagging components 402 operate in an execution environment 401. The system for navigating tagging contexts includes one or more processors and logic encoded in one or more tangible media for execution by the one or more processors that when executed is operable for identifying, in a first tagging context, a first tagging of a first resource with a first tag.

In FIG. 4A, a tagging component 402a is illustrated as a component of application 403a. In FIG. 4B, a tagging component 402b is illustrated as a component of network application agent 405b. In FIG. 4C, a tagging component 402c is illustrated operating external to one or more applications 403c. Execution environment 401c includes a tagging component 402c in a tagging subsystem 407c. In an aspect tagging component 402b and tagging component 402d communicate via user agent 403b and network service 403d in performing a portion of the method illustrated in FIG. 2 in block 202.

With respect to FIGS. 4A-D, a tagging component 402 may create, modify, remove, access and/or otherwise identify a tag that tags an identified resource (i.e. a tagging). The tag may be included in a matched tag as defined and described above. The tagging component 402, in one aspect, may detect and/or otherwise identify a tagging by creating a tagged association, by accessing a tagged association from a memory location, such as a location in a tagged store 414, and/or by otherwise detecting a tagged association. The tagging component 402 may determine that a tagged association identifies a tagging of a resource with a tag and/or a matched tag. A tagging component 402 may be invoked to identify one or more taggings in response to an access to a resource, an identifier of a resource, an attribute of a resource, and/or a tag in one or more of the taggings.

Identifying a tagging, in a tagging context, may include determining whether the tagging is in the tagging context. A tagging that is not in particular tagging context may not be relevant to a user, task, location, and/or device—to name a few examples. With respect to FIG. 2, detecting the first tagging, in the first tagging context, may include determining that the first tagging is in the first tagging context. In FIG. 4A-D, the first tagging context may be specified and/or otherwise defined by a first tagging context specification that is created, deleted, maintained, and/or otherwise accessed by a context director component 404. A tagging component 402 may interoperate with the context director component 404 to identify the first resource, the first tag, and/or the first tagging to the context director component 404. The context director component 404 may operate to determine whether the first tagging is in the first tagging context. As defined above, the first tagging context specification may include, identify, and/or may otherwise be based on one or more of various criteria. The first tagging context specification may identify a first scope descriptor, one or more tags which may include the first tag in the first tagging, a first context condition, and/or other suitable context criterion or context criteria. The one or more tags may be and/or may be identified by one or more matched tags. As defined above a context condition is a context criterion that is processed to determine whether a tagging context is active for a tagging.

A tagging of a resource with a tag may be detected and/or otherwise identified in response to an access to the resource. In FIG. 4A, tagging component 402a may determine and/or identify a tagging in response to a user input detected by an input device. The user input may correspond to a UI element, presented via an output device by a UI element handler component 433a, that represents a resource. The UI element handler component 433a associated with the presented UI element may receive input information that identifies the resource. In response, the UI element handler component 433a may identify the resource to tagging component 402a. Tagging component 402a may locate and/or otherwise identify one or more tagged associations that respectively identify taggings of the resource that may be tagged with one or more tags and/or matched tags.

Identifying a tagging in a tagging context may include determining that a context condition included in specifying the tagging context indicates that the tagging context is active for the tagging. In With respect to the previous paragraph, tagging component 402a may identify, directly and/or indirectly, a tagging to context director component 404a. The first tagging context specification may identify a first context condition. Context director component 404a may operate to determine if the identified tagging is in the first tagging context by determining whether the first tagging context is active with respect to the tagging. Context director component 404a may determine whether the first tagging context is active by determining whether the first context condition is met. In FIG. 6A, context information presented in condition UI element 610a indicates that a context condition specified based on the context information is met for a user in an “R&D” department or a “Test” department.

Alternatively or additionally, a tag director component 408 may operate to create, delete, and/or otherwise maintain one or more tagging-attribute associations, defined above. In FIG. 4B, a tag director component 408b may store a tagging-attribute association in a memory location, which may be volatile, and/or in a memory location that may be persistent. Tag director component 408b may operate in an execution environment 401b of a user node 502 to communicate via network 504 with a network service 403d in an execution environment 401d of a service node 506 to store a tagging-attribute association in a location in a tagged store 414d, a tagging store 416d, and/or any other storage accessible to execution environment 401d. Tag director component 408b, in FIG. 4B, may interoperate with tag director component 408d to create, delete, update, and/or otherwise maintain the tagging-attribute association. A change to an attribute may be reported to tag director component 408b. Tag director component 408b may identify one or more matched tags that identify tagging criterion based on the changed attribute. Tag director component 408b may interoperate with tagging component 402b and/or tagging component 402d to identify one or more taggings of one or more resources tagged with tags respectively identified by the one or more matched tags.

As described above, a tagging context specification may identify a tag identified by a matched tag. Determining whether a tagging of a resource with a tag is in a tagging context may include determining that the tag in the tagging matches a context criterion specified in a tagging context specification that defines the tagging context. The context criterion may simply identify the tag, may identify a matched tag that identifies the tag, and/or may identify any other suitable criterion for matching the tag. With respect to FIG. 2, identifying the first tagging may include determining that the first tag is identified by a first matched tag identified by a first tagging context specification for the first tagging context. With respect to the previous paragraph, tagging component 402b may interoperate with context director component 404b to identify the first tagging, the first tag, the first resource, and/or a first matched tag that identifies the first tag to context director component 404b. In an aspect, the first tagging context specification may identify a first matched tag in a context criterion. The context criterion may be defined to be met when a tag in a tagging is identified by the first matched tag and/or any other matched tags identified in the first tagging context specification. Context director component 404b may identify the first matched tag and/or a first tagging criterion of the first matched tag to a criterion match component 412b. Criterion match component 412b may operate to determine whether the first tagging tags the first resource with the first tag by tagging the first resource with the first matched tag. Criterion match component 412b may determine whether the first tagging criterion is met for the first resource. If the tagging criterion is met, criterion match component 412b may detect that the first tagging tags the first resource with the first matched tag.

In yet another aspect, identifying a tagging for a resource may include tagging the resource with a tag. With respect to FIG. 4A-D, a tag director component 408 may interoperate with a tagging component 402 to tag a resource, in response to accessing and/or otherwise identifying the resource. A tag may be identified by a matched tag. Detecting a tagging of a resource may include determining that a tagging criterion, identified by the matched tag, is met for the resource. Detecting the tagging may include tagging the resource with the tag identified by the matched tag, in response to determining that the first tagging criterion is met. Alternatively or additionally, for a matched tag, tagging may be performed in response to receiving criterion information identifying a tagging criterion identified by the match tag that identifies the tag. When a tagging criterion is met for a resource, as determined by a criterion match component 412, a tagging component 402 may tag the resource with the matched tag; and thus detect the tagging. In FIG. 4C, at the direction of tagging component 402c, tag director component 408c may retrieve and/or otherwise identify a first tagging criterion in a first matched tag. The first tagging criterion may be provided to and/or otherwise may be identified to criterion match component 412c, by tag director component 408c and/or by tagging component 402c. Criterion match component 412c may determine that the first tagging criterion is met for the resource. In response, tagging component 402c may operate to tag the resource with the first matched tag that includes the first tagging criterion.

As described above a tagging context specification may identify one or more resource scopes defined by respective scope descriptors. Whether a tagging is in a tagging context may depend on whether the resource tagged with the tag in the tagging is in a resource scope included in specifying the tagging context. A resource scope may be defined and/or otherwise identified by a scope descriptor. With respect to the previous paragraph, a scope director component 418c, in FIG. 4C, may create, modify, remove, access and/or otherwise identify a scope descriptor. A scope descriptor may be accessed by scope director component 418c from any suitable data store, such a scope store 445c Identifying a tagging in a tagging context may include determining that a resource in the tagging is in a resource scope defined by a scope descriptor included in specifying the tagging context. Context director component 404c interoperate with scope director component 418c to access a scope descriptor identified by a tagging context specification that defined the tagging context. The resource in the tagging may be identified to a scope match component 420c along with one or more scope criterion identified by the scope descriptor. Scope match component 420c may evaluate the one or more scope criterion in the scope descriptor to determine whether the resource is in the resource scope identified by the scope descriptor. If the one or more scope criterion are determined to be met for the resource by the scope match component 420c the resource is in the resource scope. Scope match component 420c and/or scope director component 418c may communicate with context director component 404c indicating the resource in the tagging is in the resource scope identified by the tagging context specification. With respect to FIG. 2, identifying the first tagging may include determining that the first resource is in a first resource scope included in defining the first tagging context. Identifying the first tagging may include determining that the first resource is in the first resource scope as defined by a first scope descriptor.

In still another aspect, detecting a tagging, in a tagging context, may include receiving an input indication to perform a search for one or more resources tagged with one or more specified tags. The one or more tags may be identified by a tagging context specification that defines the tagging context. With respect to FIG. 4A-D, a tagging component 402 may create and otherwise receive information identifying a tag and/or a matched tag and a resource for storing a tagged association in any suitable way and at any suitable time. For example, a tag handler component 410 may be invoked in response to a user input corresponding to a tag represented and/or otherwise identified via an output device. The tagging component 402 may operate to locate one or more taggings of resources tagged with the tag. As result, the tagging component 402 may identify one or more tagged associations that identify taggings.

In an aspect, a context condition may be based on a tag. A tagging context may be active for one tag and not active for another. A tagging context may be active for one matched tag and not active for another matched tag. The matched tags may identify the same or different tags. With respect to FIG. 2, the first resource may be in the first tagging context based on first context condition being met indicating that a first tagging context is active, where the first context condition is included in defining and/or otherwise specifying the first tagging context. With respect to FIGS. 4A-D, a context director component 404 may determine that a first tagging context specification identifies one or more tags, such as a first matched tag. The context director component 404 may provide the one or more tags to a tagging component 402. The tagging component 402 may locate one or more tagged associations that identify any of the respective one or more tags, such as a first tagging that identifies a first tag and first resource. The first tag may be and/or may be identified by a first matched tag with a tagging criterion that is met for the first resource. Tagging component 402 may identify the first tagging and any other located taggings to the context director component 404 indicating that the first tagging context is active for the first tagging and/or any others taggings for which required context conditions are also met. Identifying a first tagging of a first resource by a first tag may include determining whether the first tag is identified by a first matched tag included in specifying the first tagging context. Identifying a tagging in a tagging context may include determining that the tagging context is active for the tagging.

Returning to FIG. 2, a block 204 illustrates that the method further includes determining that the first tagging is in a second tagging context. Accordingly, a system for navigating tagging contexts includes means for determining that the first tagging is in a second tagging context. For example, the arrangement in FIG. 3, includes context director component 304 that is operable for determining that the first tagging is in a second tagging context. FIGS. 4A-D illustrate context director components 404 as adaptations and/or analogs of context director component 304 in FIG. 3. One or more context director components 404 operate in an execution environment 401. The system for navigating tagging contexts includes one or more processors and logic encoded in one or more tangible media for execution by the one or more processors that when executed is operable for determining that the first tagging is in a second tagging context.

In FIG. 4A, a context director component 404a is illustrated as a component of application 403a. In FIG. 4B, a context director component 404b is illustrated as a component of network application agent 405b. In FIG. 4C, a context director component 404c is illustrated operating external to one or more applications 403c. Execution environment 401c includes a context director component 404c in tagging subsystem 407c. In an aspect context director component 404b and context director component 404d communicate via user agent 403b and network service 403d in performing a portion of the method illustrated in FIG. 2 in block 204.

Just as a first tagging context specification may include and/or otherwise identify various context criterion defining a first tagging context. A second tagging context specification may include and/or otherwise identify various context criterion defining a second tagging context. For example a second tagging context may be specified and/or other defined based on a scope descriptor, one or more tags some or all of which may be matched tags, and a context condition. Determining that a tagging, in first tagging context, is also in a second tagging context may be performed in the same and/or analogous manner described above for determining that the tagging is in the first tagging context. A tagging may create an association between a first tagging context and a second tagging context. Detecting such relationships is described in more detail below.

A tag handler component 410 may be invoked, in response to a user input that targets and/or that otherwise corresponds to a tag UI element, representing a first tagging. The tag handler component 410 may process information received in response to the user input as selection information and may identify the first tagging represented by the tag UI element. A tagging component 402 may, based on identification of the first tagging by the tag handler component 410, invoke and/or otherwise interoperate with a context director component 404 to determine that the first tagging is included in and/or otherwise identified by one or more tagging contexts specified by one or more respective tagging context specifications. Context director component 404 may identify and/or locate a first tagging context specification associated with the first tagging based on any suitable information available. For example, context director component 404 may identify the first tagging context by locating the tagging context specification stored in a memory location. As described above, the context director component 404 may determine whether the first tagging is in the first tagging context by determining and/or otherwise providing for determining whether one or more context riteria identified by the first tagging context specification are met for the first tagging. The context director component 404 may identify a second tagging context specification identifying a second tagging context and determine whether the first tagging is in a second tagging context defined by the second tagging context specification similarly.

As described a first tagging context including a first tagging may be defined and/or otherwise specified based on a first tagging context specification managed by a context director component 404, in any of FIGS. 4A-D. Similarly, a second tagging context may be defined and/or otherwise specified based on a second tagging context specification managed by the context director component 404. The context director component 404 may determine that the first tagging is in the second tag context by interoperating with various components based on one or more context criterion identified in the second tagging context specification.

In an aspect, a first tagging context may be specified by a first tagging context specification that identifies and/or is otherwise based on a first resource scope. A first tagging, that tags a first resource with a first tag, may be in the first tagging context based on the first resource being in the first resource scope. The first resource scope may be specified by a first scope descriptor. In FIG. 4A, a scope director component 418a and a scope match component 420a may interoperate in processing the first scope descriptor to determine that the first resource is in the first scope. A second tagging context may be specified by a second tagging context specification that identifies and/or is otherwise based on a second resource scope. Determining that the first tagging is in the second tagging context may include determining that the first resource is in the second resource scope. Scope director component 418a and scope match component 420a may interoperate in processing a second scope descriptor that specifies the second resource scope to determine that the first resource is in the second scope.

Determining that a resource is in a resource scope defined by a scope descriptor includes determining that a scope criterion in the scope descriptor is met for the resource. With respect to the previous paragraph, determining that the first tagging is in the second resource scope may include determining that a second scope criterion identified by the second scope descriptor is met for the first resource. As described, context director component 404a may access the second tagging context and identify the second scope descriptor. Context director component 404a may communicate directly and/or indirectly with scope director component 418a to identify the second scope descriptor. Scope director component 418a, may access the second scope descriptor. Scope director component 418a may identify the second scope criterion to scope match component 420a to determine whether the second scope criterion is met for the first resource or not. The result of the determination may be communicated to context director component 404a to determine whether the first tagging is in the second tagging context. In an aspect, a scope criterion may be processed in the role of a scope condition. When a scope condition in a scope descriptor is met, the resource scope specified by the scope descriptor is active. As such, scope match component 420a may operate to determine that a second scope condition included in and/or identified by the second scope criterion is met. The first resource may be in at least a portion of a first scope that is included in the second scope.

In an aspect, a first tagging context may be specified by a first tagging context specification that identifies and/or is otherwise based on a first context criterion that is met based on the first tag. A first tagging, that tags a first resource with a first tag, may be in the first tagging context based on the first context criterion being met for the first tag in the first tagging. For example, the first context criterion may identify and/or otherwise match the first tag. The first context criterion may identify a first matched tag that identifies the first tag and that identifies a first tagging criterion that is met for the first resource. In FIG. 4B, context director component 404b may access the first tagging context specification. Context director component 404b may identify the first context criterion to tagging component 402b and/or criterion match component 412b to determine whether the first context criterion is met for the first tag in the first tagging. The result may be communicated to scope director component 404b to determine that the first tagging is in the first tagging context based on the result. A second tagging context may be specified by a second context criterion that is met based on the first tag. Determining the first tagging is in the second tagging context may include determining that the second context criterion is met for the first tag. Tagging component 402b and criterion match component 412b may interoperate in processing the second context criterion to determine that the second context criterion is met for the first tag.

The description above with respect to FIG. 4B may be performed by the arrangement of components in FIG. 4D. Alternatively or additionally, some or all of the arrangement in FIG. 4B operating in execution environment 401b may interoperate with some or all of the arrangement in FIG. 4D in execution environment 401d via a network, such as network 504 in FIG. 5.

In an aspect, the second context criterion may identify a second matched tag. Determining that the second context criterion is met for the first tagging may include determining that a second tagging criterion identified by the second matched tag is met for the first resource. The second matched tag may identify the first tag.

In an aspect, a first tagging context may be specified by a first tagging context specification that identifies and/or is otherwise based on a first context criterion that is met for the first tagging. A first tagging, that tags a first resource with a first tag, may be in the first tagging context based on the first context criterion being met for the first tagging. For example, the first context criterion may a first user. The first context criterion may be met when the first user is logged in. The first context criterion may identify the user directly by identifying an unique identifier to match a logged in user and/or may identify the first user indirectly by, for example, an expression that is met based on one or more attributes of the first user when logged in. In FIG. 4C, context director component 404c may access the first tagging context specification. Context director component 404c may identify the first context criterion to criterion match component 412c to determine whether the first context criterion is met for the first tagging. The result may be communicated to scope director component 404c to determine that the first tagging is in the first tagging context based on the result. A second tagging context may be specified based on a second context criterion. In an aspect, the second context criterion may be met based on a location of the first user. When the first user is in a first location the criterion match component 412c may determine that the second context criterion is met. Determining the first tagging is in the second tagging context may include determining that the second context criterion is met based on the first location of the first user.

In an aspect, the second context criterion may be and/or otherwise may include a second context condition that is met for the first tagging indicating the second tagging context is active for the first tagging. For example, the second context condition may be based on location of a user as described in the previous paragraph. As described in the previous paragraph, determining that a first tagging is in a first tagging context may include determining that first context condition is met. The first context condition is identified by a first tagging context specification that defines the first tagging context. Analogously, determining that the first tagging, in the first tagging context, is also in a second tagging context may include determining that that a second context condition is met. The second context condition is identified by the second tagging context specification that defines the second tagging context. Determining that the second context condition is met indicates that the second tagging context is active for the first tagging. The first tagging may be included in the second tagging context based on the second context condition being met.

A context criterion included in defining a tagging context may include and/or otherwise may be based on a user, a group, a permission, a role, a resource, a tag, a location, a legal entity, a time, a task, an operation, and/or a duration—to name a few examples.

Also as described above, determining that a first tagging is in a first tagging context may include determining that a first tag, that tags a first resource in the first tagging, matches a context criterion in a first tagging context specification that defines the first tagging context. The context criterion may identify a first matched tag that identifies the first tag and determining that the first tagging is in the first tagging context may include determining that a first tagging criterion identified by first matched tag is met for the first resource. Analogously, determining that the first tagging, in the first tagging context, is in a second tagging context may include determining that the first tag in the first tagging of the first resource is matches a context criterion identified by a second tagging context specification that defines the second tagging context. The criterion may identify a identified by a matched tag and determining that the first tagging is in the second tagging context may include determining that a tagging criterion identified by the matched tag is met for the first resource. The matched tag in the second tagging context specification may be a second matched tag that is in a second tagging of the first resource. The second matched tag may identify the first tag or a different tag. The first tagging may be in the first tagging context and the second tagging may be in the second tagging context.

Further in FIG. 2, a block 206 illustrates that the method yet further includes detecting, in the second tagging context and in response to identifying the first tagging, a second tagging, wherein the second tagging is not in the first tagging context. Accordingly, a system for navigating tagging contexts includes means for detecting, in the second tagging context and in response to identifying the first tagging, a second tagging, wherein the second tagging is not in the first tagging context. For example, the arrangement in FIG. 3, includes context navigator component 306 that is operable for detecting, in the second tagging context and in response to identifying the first tagging, a second tagging, wherein the second tagging is not in the first tagging context. FIGS. 4A-D illustrate context navigator components 406 as adaptations and/or analogs of context navigator component 306 in FIG. 3. One or more context navigator components 406 operate in an execution environment 401. The system for navigating tagging contexts includes one or more processors and logic encoded in one or more tangible media for execution by the one or more processors that when executed is operable for detecting, in the second tagging context and in response to identifying the first tagging, a second tagging, wherein the second tagging is not in the first tagging context.

In FIG. 4A, a context navigator component 406a is illustrated as a component of application 403a. In FIG. 4B, a context navigator component 406b is illustrated as a component of network application agent 405b. In FIG. 4C, a context navigator component 406c is illustrated operating external to one or more applications 403c. Execution environment 401c includes a context navigator component 406c in tagging subsystem 407c. In an aspect context navigator component 406b and context navigator component 406d communicate via user agent 403b and network service 403d in performing a portion of the method illustrated in FIG. 2 in block 206.

For a first tagging in a first tagging context and in a second tagging context, detecting a second tagging in the second tagging context, in response to identifying a first tagging in a first tagging context, may include identifying an association between or among resources, tags, resource scopes, and tagging contexts. Such associations may be via and/or otherwise based on a tag, a matched tag, a resource, a resource scope, an intersection of resource scopes, a context condition, a tagging criterion, a scope criterion and/or any other entity included in determining whether a tagging is in tagging context such a user, a group, and/or a location—to name a few examples.

As described a first tagging context including a first tagging may be defined and/or otherwise specified based on a first tagging context specification managed by a context director component 404, in any of FIGS. 4A-D. Similarly, a second tagging context may be defined and/or otherwise specified based on a second tagging context specification managed by the context director component 404. The context director component 404 may invoke a context navigator component 406 to detect a second tagging in a second tagging context, in response to identifying a first tagging in a first tagging context. The context navigator component 406 may interoperate with various components based on one or more context criterion identified in the second tagging context specification.

In an aspect, a first tagging context may be specified by a first tagging context specification that identifies and/or is otherwise based on a first resource scope. A first tagging, that tags a first resource with a first tag, may be in the first tagging context based on the first resource being in the first resource scope. The first tagging may be in a second tagging context based on the first resource being in a second scope identified by a second tagging context specification that identifies the second scope. The first resource scope may be specified by a first scope descriptor. Detecting a second tagging in the second tagging context may include detecting that a second resource tagged with a tag in the second tagging is in the second resource scope. In FIG. 4A, context navigator may interoperate with a scope director component 418a and a scope match component 420a in processing the second scope descriptor to determine that the second resource is in the second scope. The second resource may be included in at least a portion of the second resource scope that is not included in the first resource scope. Scope director component 418a and scope match component 420a may interoperate in processing a second scope descriptor that specifies the second resource scope to determine that the second resource is in the second scope.

Determining that a resource is in a resource scope defined by a scope descriptor includes determining that a scope criterion in the scope descriptor is met for the resource. With respect to the previous paragraph, detecting a second tagging in the second resource scope may include determining that a second scope criterion identified by the second scope descriptor is met for a second resource in the second tagging. As described, context director component 404a may access the second tagging context and identify the second scope descriptor. Context director component 404a may communicate with context navigator component 406a to communicate directly and/or indirectly with scope director component 418a to identify the second scope descriptor. Scope director component 418a, may access the second scope descriptor. Scope director component 418a may identify the second scope criterion to scope match component 420a to determine whether the second scope criterion is met for the second resource or not. The result of the determination may be communicated to context navigator component 406a to determine whether the second tagging is in the second tagging context. In an aspect, a scope criterion may be processed in the role of a scope condition. When a scope condition in a scope descriptor is met, the resource scope specified by the scope descriptor is active. As such, scope match component 420a may operate to determine that a second scope condition included in and/or identified by the second scope criterion is met for a second resource. The second resource may be in at least a portion of a second resource scope that is not included in the first resource scope. In a further aspect, detecting a second tagging in a second tagging context based on a first tagging in a first tagging context may include determining that a second resource in the second tagging is not in the first resource scope. Context director component 404a, context navigator component 406a, scope director component 418a, and/or scope match component 420a may operate as described to determine whether a resource in a tagging is in a resource scope, in order to determine whether the tagging is in a tagging context. Determining that a resource is not in a resource scope may include determining that a scope criterion included in specifying the resource scope is not met for the resource. As described a scope criterion may be and/or may otherwise include a scope condition. Determining that a resource is not in a resource scope may include determining that a scope condition in specifying the resource scope is not met for the resource.

In an aspect, a first tagging context specification, that defines a first tagging context, may identify a first tag that tags a first resource in a first tagging that is in the first tagging context. The first tagging may be in a second tagging context defined by second tagging context specification that identifies and/or otherwise matches the first tagging. The second tagging context specification may identify a second matched tag that identifies a second tagging criterion that is met for a second resource. In FIG. 4B, context navigation component 406b may detect a second resource tagged with the second matched tag via the tagging component 402b and the criterion match component 412b. The context director component 404b may confirm and/or otherwise determine that the second tagging of the second resource with the second matched tag is in the second tagging context. The first tagging specification may identify a first tagging criterion identified by a first matched tag. The first tagging criterion may be met for the first resource and may not be met for the second resource, in an aspect. The first matched tag may identify the first tag. The second tagging context specification may identify a second matched tag that identifies the first tag or may identify another tag. The first tagging criterion of the first matched tag and a second tagging criterion of the second matched tag may both be met for the first resource.

In another aspect, a second tagging context specification may identify a second matched tag that identifies a second tagging criterion that is met for the first resource. In FIG. 4C, context navigation component 406c may detect the first resource tagged with the second matched tag via the tagging component 402c and the criterion match component 412b. The context director component 404b may confirm and/or otherwise determine that the second tagging of the first resource with the second matched tag is in the second tagging context. The first matched tag may identify the first tag. The second tagging context specification may identify a second matched tag that identifies the first tag or may identify another tag. The first tagging criterion of the first matched tag and a second tagging criterion of the second matched tag may both be met for the first resource. The first tagging of the first resource may be in the first tagging context and the second tagging of the first resource may be in the second tagging context. The first tagging may be in the second tagging context and the second tagging context may be in the first tagging context in some aspects and may not be in the first tagging context, in others.

The description above demonstrates that a first tagging context specification, that defines a first tagging context, may identify a first context criterion, such as first resource scope, a first tag, a first matched tag, etc. A first tagging may be in the first tagging context based on a determination that the first context criterion is met for the first tagging. The first tagging may be in a second tagging context defined by second tagging context specification that identifies and/or otherwise is based on a second context criterion. The first tagging may be in the second tagging context based on a determination that the second context criterion is met for the first tagging. In FIG. 4C, a context navigator component 406c may interoperate with various components, depending on the second tagging context specification, to detect a second tagging that is in the second tagging context. The second tagging may be in the second tagging context based on determining that the second context criterion is met for the second tagging. Context navigation component 406c may detect a second tagging that tags a resource with a tag. The second tagging may tag the first resource or may tag a second resource. The second resource may tag the resource it identifies with the first tag or with a second tag. The second tagging may be detected, located, and/or otherwise identified by tagging component 402c, which may interoperate with criterion match component 412c. The context director component 404b may confirm and/or otherwise determine that the second tagging is in the second tagging context in response to determining that the second context criterion is met for the second tagging. In some circumstances, the second context criterion included in defining the second tagging context may be not be met for the first tagging and may be met in other circumstance and/or for another tagging in the first tagging context.

In addition to examples of already provided above, a context criterion may identify and/or otherwise may be based on a user, a group, a permission, a role, a resource, a tag, a location, a legal entity, a time, a task, an operation, and/or a duration.

In an aspect, detecting such a second tagging may include identifying another tagging based on a resource scope, an intersection of resource scopes, a scope criterion (e.g. scope condition). Detecting that the second tagging in the second tagging context may include determining, by context director component 404a that a resource tagged by a tag in the second tagging is in a second resource scope defined by the second scope descriptor included in specifying the second tagging context. With respect to FIG. 2, a second resource may be associated with the first resource by being in the first resource scope as determined by scope director component 418a and scope match component 420a. Tagging component 402a may determine that the second resource is tagged with a tag in a second tagging. The tag in the second tagging may be the first tag or a different tag. In an aspect, the resource in the second tagging may be the first resource, as described above.

Assuming, that the first tagging criterion is met for the second resource, the second resource might not be in a first scope required by the first tagging context. That is the first tagging may be in the first tagging context based on a first resource scope that includes the first resource. The first tagging may be in the second tagging based second resource scope that includes the first resource. FIG. 4C, context navigation component 406c may detect that a second resource is in the second resource scope. The second resource may be in a second tagging that tags the second resource with the first tag or a different tags. The second tagging may tag the second resource with a matched tag which may be the same matched tag in the first tagging or a different matched tag that identifies the first tag or a different tag. The context director component 404b may confirm and/or otherwise determine that the second tagging of the second resource in the second resource scope is in the second tagging context. The first resource may or may not be in the second resource scope, depending on any overlap between the first resource scope and the second resource scope.

As described above, determining that a tagging is in a tagging context may include determining that a context condition included in specifying the tagging context is met. That is, determining that a tagging is in a tagging context may include determining that the tagging context is active. Whether a context is active may vary from tagging to tagging. Determining that the second context condition is met may indicate that the second tagging context is active with respect to the second tagging. The second context condition may indicate that the second tagging context is not active for another tagging context.

As described above, identifying a tagging, in a tagging context may include determining that the tagging is in the tagging context. A tagging context is defined and/or otherwise specified by a tagging context specification. The tagging context specification may identify and/or may otherwise may be based on any suitable entity for specifying a context criterion. Examples of a context criterion include a scope descriptor, a tag, a matched tag, a context condition, and/or a tagging criterion. The resource may be in a resource scope defined by a scope descriptor. Identifying the tagging, in the tagging context, may include determining that the resource is in the resource scope. Identifying the tagging, in the resource scope, may include determining that a context condition, included in specifying the tagging context, is met indicating the tagging context is active for the resource. Identifying the tagging, in the tagging context, may include determining that the tag in the tagging is identified by a matched tag, where the tagging context is specified based on the matched tag. Identifying the tagging, in the tagging context, may include determining that a tagging criterion identified by the matched tag is met for the resource tagged by the tagging.

Also as described above, a first tagging context may be defined and/or otherwise specified by a first tagging context. A second tagging context may be defined and/or otherwise specified by a second tagging context. The first tagging context may identify a first scope descriptor that specifies a first resource scope. The second tagging context may identify a second scope descriptor that specifies a second resource scope. The first tagging may tag a first resource with a first tag. The first tagging may be in the first tagging context based on the first resource being in the first resource scope. Determining that the first tagging is in the second tagging context may include determining that the first resource is in the second scope. The first resource, in such an aspect, may be in some or all of the first resource scope that is in the second resource scope. That is, the two resources scopes have an intersection that includes at least the first resource. Detecting a second tagging may include determining that the second tagging identifies a second resource that is the second scope. Determining that the second resource is in the second scope may include determining that a second scope criterion included in specifying the second scope descriptor is met for the first resource. The second scope criterion may be and/or may include a second scope condition that when met indicates the second resource scope is active for the second resource. In an aspect, the second resource may be in a portion of the second scope that is not included in the first scope. Detecting the second tagging may include determining that the second tagging is not in the first tagging context. Determining that the second tagging is not in the first tagging context my include determining the a first scope criterion included in specifying the first resource scope is not met for the second resource. The first scope criterion may be and/or may include a first scope condition. Determining that the second resource is not in the first scope may include determining that the first scope condition is not met for the second resource indicating that the first resource scope is not active for the second resource.

In another aspect, a context criterion may be based on a tag, referred to herein as a tag-based context criterion. The first tagging may be in the first tagging context based on a first tag-based context criterion. The first tag-based context criterion may be met based on the first tag in the first tagging. The second tagging context may be specified based on a second tag-based context criterion. Determining that the first tagging is in the second tagging context may include determining that the second tag-based context criterion is met. In a further aspect, a tag-based context criterion may be and/or may include a tagging criterion identified by matched tag that a tagging context specification may be based on. The first tagging may be in the second tagging context based on a second tagging criterion identified by a second matched tag that identifies the first tag. The first tagging may tag the first resource with the first tag via the second matched tag. Determining that the first tagging is in the second tagging context may include determining that the second tagging criterion is met for the first resource. Detecting the second tagging may include determining that the second tagging is not in the first tagging context. Determining that the second tagging is not in the first tagging context my include determining that the first tag-based context criterion is not met for a tag in the second tagging. In an aspect, the second tagging may tag the first resource with a second matched tag. The first tag-based context criterion may identify a first matched tag. The second matched tag may not match the identified first matched tag. The second matched tag may identify the first tag or some other tag. In another aspect, the second tagging may tag a second resource with a tag. The first tag-based context criterion may be based on the first matched tag that identifies the first tag and a first tagging criterion. The first tagging criterion may not be met for the second resource.

In general terms, a first tagging context may be specified based on first context criterion. A first tagging that tags a first resource with a first tag may be in the first tagging context based on the first context criterion. A second tagging context may be specified based on a second context criterion. Determining that the first tagging is in the second tagging criterion may include determining that the second context criterion is met for the first tagging. The second context criterion may be and/or may otherwise include a second context condition that when met indicates that the second tagging context is active for the first tagging. Determining that the first tagging is in the second tagging criterion may include determining that the second tagging context is active for the first tagging. Detecting a second tagging may include determining that the second tagging context is based on a second context criterion. Detecting the second tagging may further include determining that the second context criterion is met for the second tagging. As with the first context criterion, the second context criterion may include a second context condition. Determining that the second tagging is in the second tagging context may include determining that the second context condition is met indicating that the second tagging context is active for the second tagging. In a further aspect, the first context criterion may not be met for the second tagging. If the first context criterion is and/or otherwise includes the first context condition, detecting the second tagging may include determining that the first context condition is not met indicating the first tagging context is not active for the second tagging. A context criterion may identify, match, and/or otherwise may be based on any suitable data. For example, a context criterion may be based on a user, a group, a permission, a role, a resource, a tag, a location, a legal entity, a time, a task, an operation, and/or a duration—to name a few examples.

The method illustrated in FIG. 2 may include additional aspects supported by various adaptations and/or analogs of the arrangement of components in FIG. 3.

In an aspect, a context condition may identify a definition for tag. In FIGS. 4A-D, a context director component 404 may interoperate with a criterion match component 412 to determine that a context condition may be met when a tag in a tagging is assigned and/or otherwise associated with a definition. The context director component 404 may determine that the tagging is in the tagging context by detecting that the context condition identifies the definition and by determining that the tag in the tagging is defined by the identified definition.

Determining that a tagging is in a tagging context may include receiving context information identifying the tagging context. Context information, for example, may be and/or may otherwise identify a tagging context specification that defines the tagging context. In an aspect, some or all of a tagging context specification may be specified and/or otherwise identified by a user of a system included in performing the teachings included herein. The tagging context specification may be specified and/or identified in response to interaction with the user. In FIG. 6A-D, exemplary user interfaces are illustrated by tagging context UI elements 604 that prompt users for context information of various types and formats. The context information may be received by a UI handler component 433 in any of FIGS. 4A-D, in response to user input, detected by an input device, that corresponds to one or more context information UI elements, such as context condition UI element 610a in FIG. 6A, save button UI element 614b in FIG. 6B, and/or tags UI element 622c in FIG. 6C. Some or all of the choices a user may select and/or some or all of the context criterion in a context tagging specification may be configured by an administrator, designer, tester, and/or developer of the system.

In an aspect, identifying a tagging, in a tagging context may include receiving user information that identifies a user. The tagging context may be identified in response to receiving the user information. The tagging may be identified based on the tagging context. In FIG. 6B, a context condition UI element 610b is illustrated. The context condition UI element 610b may be presented, in an aspect, by a UI element handler component 433b operating in an execution environment 401b of a user agent node, such as user agent node 502 in FIG. 5. The UI element handler component 433b may present the UI element based on data exchanged with context director component 404b and/or context director component 404d in FIG. 4D. Context director component 404d may operate in execution environment 401d of service node 506. Context condition UI element handler component 433b and/or context director component 404b may communicate with context director component 404d via network 504. Context condition element 610b illustrates context information for a context condition that is met for a tagging when the creator of the tagging is the user current interacting with execution environment 401b and optionally execution environment 401d via network 504. Taggings identified as being in the tagging context specified based on the context information illustrated in FIG. 6B will differ from user to user.

The second user information may be received based on a relationship between a first user and the second user. The first tagging may be identified by determining, based on the first user, that the first tagging is in the first tagging context. The second user information may be received from and/or otherwise based on the first user. The relationship between the first user and the second user may be detected based on receiving the second user information from the first user. In FIG. 6A, a context condition is specified based on context information received via context condition UI element 610a that identifies a user based on groups. Users are related by groups that include them.

A relationship between a first user and a second user may be based on one or more of a match between first metadata for the first user and second metadata for the second user, a group, a social relationship, a business relationship, a task, a date, a time, a location, a legal entity, a hoppy, and a topic—too name a few examples.

In another aspect, identifying a tagging, in a tagging context, of a resource with a tag may include receiving resource information identifying the resource and/or receiving tag information identifying the tag. The tagging context may be identified in response to receiving the resource information and/or the tag information. In FIG. 6C, a tags UI element 622c allows a user to see and select one or more tags or matched tags as context information for specifying a tagging context specification that identifies a tagging context. Identifying a tagging in the tagging context may include identifying a tagging that identifies a tag and/or matched tag identified via tags UI element 622c. Context criterion UI element 620b in FIG. 6B illustrates scope criterion information specifying a scope descriptor included in defining a tagging context. Identifying a tagging in the tagging context may include identifying a resource in the specified resource scope.

With respect to FIG. 2, the first tag that tags a first resource in a first tagging may be associated with a first definition and may be in the first tagging context based on the first definition. For example, the first context condition may be met based on the association of the first definition with the first tag. The first tag in the first tagging may also be associated with a second definition. For example, the first tag may have a primary definition and a secondary definition. The first tagging may be in the second tagging context based on the second definition. The second context condition and/or a another context criterion may be met based on the association of the second definition with the first tag. In a second tagging, the first tag may be associated with the second definition. The second tagging may be in the second tagging context based on the second definition. The second context condition and/or another context criterion may be met based on the association of the second definition with the first tag.

With respect to FIG. 2, the first tagging context may include one or more taggings that make up a first tagging set that includes the first tagging. The second tagging context, similarly may include one or more taggings that makeup a second tagging set that includes the first tagging. The second tagging when not in the first tagging context may be a portion of the second tagging set that is not in the first tagging set. The first tagging may be included in an intersection of the first tagging set and the second tagging set. The intersection and the first tagging set may be equal. In another aspect, the first tagging set may include a tagging that is not in the second tagging set.

The method illustrated in FIG. 2 may include exchanging a message via a network with a remote execution environment. The message may be sent to the remote execution environment. The sent message may include a request and/or a response to a request. In another aspect, the message may be received from the remote execution environment. The received message may include a response and/or a request.

In still another aspect, determining that a first tagging in a first tagging context is in a second tagging context may include detecting an input corresponding to a user interface presented via an output device by a UI element handler component 433 in any of FIGS. 4A-d. the user interface may represent and/or otherwise identify the first tagging to a user. In response to detecting the user input, the UI element handler component 433 may invoke a context director component 404 to determine that the first tagging, in the first tagging context, is included in the second tagging context. Context director component 404 may identify the second tagging context to a context navigator component 406. The context navigator component 406, in response may detect a second tagging in the second tagging context. The detecting of the second tagging may be performed automatically in response to detecting the user input.

With respect to the previous paragraph, in response to determining that the first tagging is included in the second tagging context, context director component 404 may interoperate with a UI element handler component 433 to send presentation information present a representation that identifies the second tagging context, via an output device, to a user. The second tagging may detected in response to presenting the representation. In an aspect, a user input may be detected by the UI element handler component 433. The user input may correspond to the representation of the second tagging context. Context navigator component 406 may operate in response to the detection of the user input to detect the second tagging, as described above in various aspects. Context navigator component 406 may send presentation information that represents and/or otherwise identifies the second tagging, via an output device, to a user, in response to detecting the second tagging.

A resource tagged by a tag in a tagging may include text data, image data, audio data, form data, streaming data, a user, a group, a legal entity, an executable program component, a hardware component, a service, and/or a process—too name a few examples.

In an aspect, determining that the first tagging is in the second tagging context may include determining a plurality of tagging contexts that include the first tagging. Presentation information may be sent to present at least a representation that identifies the second tagging context, via an output device, along with a representation of the first tagging. Input information may be received that corresponds to the representation of the second tagging context. The second tagging may be detected in response to receiving the input information.

In another aspect, user information may be received, via an input device from a first user, that identifies the first user. The first tagging context may be identified based on the first user. The first tagging may be identified, in response to identifying the first tagging context. Input information may be received from the first user that corresponds to the first tagging. In response to receiving the input information, presentation information may be sent to present, via an output device, a user interface representing the second tagging to the first user.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more processors, or by a combination of both. The description herein of any sequence of actions is not intended to imply that the specific order described for performing that sequence must be followed.

Moreover, the methods described herein may be embodied in executable instructions stored in a non-transitory computer readable medium for use by or in connection with an instruction execution machine, system, apparatus, or device, such as a computer-based or processor-containing machine, system, apparatus, or device. As used here, a “non-transitory computer readable medium” may include one or more of any suitable media for storing the executable instructions of a computer program in one or more forms including an electronic, magnetic, optical, and electromagnetic form, such that the instruction execution machine, system, apparatus, or device may read (or fetch) the instructions from the non-transitory computer readable storage medium and execute the instructions for carrying out the described methods. A non-exhaustive list of conventional exemplary non-transitory computer readable storage media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), and a Blu-ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

I claim:

1. A method for navigating tagging contexts, the method comprising:
identifying, in a first tagging context, a first tagging of a first resource with a first tag;
determining that the first tagging is in a second tagging context; and
detecting, in the second tagging context and in response to identifying the first tagging, a second tagging, wherein the second tagging is not in the first tagging context,
wherein performing at least one of the preceding actions comprising the method includes execution of an instruction by a processor.

2. The method of claim 1 wherein the first tagging context is specified based on at least one of a first context criterion, a first scope descriptor, a first matched tag that identifies the first tag, and a first context condition, wherein when the first context condition is met, the first tagging context is active for the first tagging.

3. The method of claim 2 wherein identifying the first tagging includes determining at least one of that the first resource is in a first resource scope specified by the first scope descriptor, that the first context condition is met indicating that the first tagging context is active for the first tagging, and that the first tag is identified by the first matched tag wherein the first resource is tagged with the first matched tag.

4. The method of claim 1 wherein the first tagging context is specified based on a first context criterion that is met for the first tagging and the second tagging context is specified based on a second context criterion that is met for the first tagging

5. The method of claim 4 wherein the first tagging context is specified based on a first context criterion that is met based on the first matched tag that identifies the first tag and the second tagging context identifies a second context criterion that is met based on a second matched tag that identifies the first tag.

6. The method of claim 1 further includes determining that the second tagging is in the second tagging context, wherein the second tagging identifies a resource and a tag.

7. The method of claim 6 wherein the second tagging context is specified by a second tagging context specification that identifies at least one of a second scope descriptor, a second tag, a second matched tag, and a second context condition and the first tagging context is specified by a first tagging context specification that identifies at least one of a first scope descriptor, the first tag, a first matched tag, and a first context condition.

8. The method of claim 7 wherein detecting the second tagging includes determining that the resource identified by the second tagging is in a second resource scope defined by the second scope descriptor, wherein the first resource is in a first resource scope defined by the first resource descriptor.

9. The method of claim 7 wherein detecting the second tagging includes determining that the resource identified by the second tagging is tagged with the second matched tag, wherein the first resource is tagged with the first matched tag.

10. The method of claim 1 wherein the first tagging is included in a first tagging set that consists of taggings in the first tagging context and included in a second tagging set that consists of taggings in the second tagging context.

11. The method of claim 10 wherein the first tagging set is included in the second tagging set.

12. The method of claim 10 wherein a portion of the first tagging set is not included in the second tagging set.

13. The method of claim 1 wherein determining that the first tagging is in the second tagging context includes:
detecting an input corresponding to a user interface presented via an output device that identifies the first tagging to a user;
automatically, in response to detecting the user input, determining that the first tagging is included in the second tagging context; and
detecting the second tagging in response to determining that the first tagging is included in the second tagging context.

14. The method of claim 13 includes:
sending presentation information to present a representation identifying the second tagging context, via an output device to a user, in response to determining that the first tagging is included in the second tagging context; and
detecting the second tagging in response to presenting the representation.

15. The method of claim 14 includes:
detecting a user input corresponding to the representation of the second tagging context, and
detecting the second tagging in response to detecting the user input.

16. The method of claim 15 includes sending presentation information to present a representation of the second tagging, via an output device, to a user.

17. The method of claim 1 wherein determining that the first tagging is in the second tagging context includes:
determining a plurality of tagging contexts that include the first tagging;
sending presentation information to present at least a representation identifying the second tagging context, via an output device, along with a representation identifying the first tagging;
receiving input information corresponding to the representation of the second tagging context; and
detecting the second tagging in response to receiving the input information.

18. The method of claim 1 further includes:
receiving a user information, via an input device from a first user, that identifies the first user;
identifying the first tagging context based on the first user;
identifying the first tagging, in response to identifying the first tagging context;
receiving input information from the first user that corresponds to the first tagging; and
in response to receiving the input information, sending presentation information to present, via an output device, a user interface representing the second tagging to the first user.

19. A system for navigating tagging contexts, the system comprising:
a tagging component or identifying, in a first tagging context, a first tagging of a first resource with a first tag;
a context director component for determining that the first tagging is in a second tagging context;
a context navigator component for detecting, in the second tagging context and in response to identifying the first tagging, a second tagging, wherein the second tagging is not in the first tagging context; and
a processor, wherein at least one of the tagging component, the context director component, and the context navigator component includes an instruction that is executed by the processor during operation of the system.

20. A non-transitory computer-readable medium embodying a computer program, executable by a machine, for navigating tagging contexts, the computer program comprising executable instructions for:
identifying, in a first tagging context, a first tagging of a first resource with a first tag;
determining that the first tagging is in a second tagging context; and
detecting, in the second tagging context and in response to identifying the first tagging, a second tagging, wherein the second tagging is not in the first tagging context.
